(19) United States
(12) Patent Application Publication
(10) Pub. No.: US 2019/0243542 A1
(43) Pub. Date: Aug. 8, 2019

(54) MULTI FUNCTION PERIPHERAL, DISPLAY SHARING METHOD, AND COMPUTER PROGRAM

(71) Applicant: Konica Minolta, Inc., Tokyo (JP)

(72) Inventor: Akira OHHATA, Toyokawa-shi (JP)

(73) Assignee: Konica Minolta, Inc., Tokyo (JP)

(21) Appl. No.: 16/257,228

(22) Filed: Jan. 25, 2019

(30) Foreign Application Priority Data
Feb. 7, 2018 (JP) 2018-020043

(51) Int. Cl. G06F 3/0488; H04N 1/00; G06F 3/0486; G06F 3/0481

(52) U.S. Cl. CPC G06F 3/04886; H04N 1/00411; G06F 2203/04803; G06F 3/04817; G06F 3/0486

(57) ABSTRACT

There is provided a multi function peripheral that includes a first system, a second system, and a display, and the multi function peripheral includes a display controller that causes the display to display a first screen of the first system and a second screen of the second system side by side, wherein the first system includes a supplier that supplies image data of an icon placed on the first screen to the second system or the display controller, and when an operation to move the icon from the first screen to the second screen is performed, the display controller causes the display to display the icon moving from the first screen to the second screen in accordance with the operation.

The entire disclosure of Japanese patent Application No. 2018-020043, filed on Feb. 7, 2018, is incorporated herein by reference in its entirety.

### BACKGROUND

### Technological Field

The present invention relates to a technology for displaying two screens side by side.

### Description of the Related Art

Image forming apparatuses having various functions such as copy, scan, facsimile, and box functions are now widely used. Such an image forming apparatus is called “multi function peripherals (MFP)” in some cases.

Meanwhile, a technique for integrally forming an image forming apparatus with a physical server (a so-called server device or unit) has recently been suggested. With such a technique, the expandability of the functions of an image forming apparatus can be increased more easily than in conventional cases. Hereinafter, an apparatus in which an image forming apparatus and a server are integrated will be referred to as a “multi function peripheral”.

Different operating systems are installed in the image forming apparatus and the server.

A touch panel display of the multi function peripheral simultaneously displays the respective screens of the image forming apparatus and the server side by side, to accept operations directed to the image forming apparatus and the server from a user.

JP 8-185301 A discloses technique for copying or moving an icon in an environment where two screens can be displayed side by side. By this technique, an icon placed on one of the two screens is dragged and dropped onto the other screen. In this manner, the file corresponding to this icon is copied or moved.

However, the technique disclosed in JP 8-185301 A is a technique to be applied in cases where two screens are displayed on a display by a single operating system.

Therefore, this technique cannot be applied in cases where the respective screens of two different systems are displayed on one display.

### SUMMARY

In view of the above problems, an object of the present invention is to enable movement of icons more easily than with a conventional technique, in a case where the respective screens of two different systems are displayed on a display.

To achieve the abovementioned object, according to an aspect of the present invention, there is provided a multi function peripheral that includes a first system, a second system, and a display, and the multi function peripheral reflecting one aspect of the present invention comprises a display controller that causes the display to display a first screen of the first system and a second screen of the second system side by side, wherein the first system includes a supplier that supplies image data of an icon placed on the first screen to the second system or the display controller, and when an operation to move the icon from the first screen to the second screen is performed, the display controller causes the display to display the icon moving from the first screen to the second screen in accordance with the operation.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a diagram showing an example of a network system including a multi function peripheral;

FIG. 2 is a diagram showing an example hardware configuration of the multi function peripheral;

FIG. 3 is a diagram showing an example hardware configuration of an MFP unit;

FIG. 4 is a diagram showing an example hardware configuration of a server unit;

FIG. 5 is a diagram showing an example hardware configuration of a panel controller;

FIG. 6 is a diagram showing example functional configurations of the MFP unit and the server unit;

FIG. 7 is a diagram showing an example functional configuration of the panel controller;

FIG. 8 is a diagram showing an example of a desktop screen;

FIG. 9 is a diagram showing an example of a desktop screen;

FIG. 10 is a diagram showing an example of a display surface and a touch surface;

FIG. 11 is a diagram showing an example of a combined screen;

FIG. 12 is a diagram showing an example of a desktop screen excluding a selected icon;

FIG. 13 is a diagram showing an example of a drag of a selected icon;

FIG. 14 is a diagram showing an example of a combined screen, with a selected icon being dropped;

FIG. 15 is a flowchart for explaining an example flow in the overall process to be performed by the MFP unit or the server unit;

FIG. 16 is a flowchart for explaining an example flow in the overall process to be performed by the panel controller;

FIG. 17 is a flowchart for explaining an example flow in the overall process to be performed by the panel controller;

FIG. 18 is a diagram showing an example functional configuration of an MFP unit;

FIG. 19 is a diagram showing an example functional configuration of a server unit;

FIG. 20 is a diagram showing an example functional configuration of a panel controller;

FIG. 21 is a diagram showing an example functional configuration of the MFP unit;

FIG. 22 is a diagram showing an example functional configuration of the server unit;

FIG. 23 is a flowchart for explaining an example flow in the overall process to be performed by the panel controller;

FIG. 24 is a flowchart for explaining an example flow in the overall process to be performed by the MFP unit or the server unit; and

FIG. 25 is a flowchart for explaining an example flow in the overall process to be performed by the MFP unit or the server unit.

### DETAILED DESCRIPTION OF EMBODIMENTS

Hereinafter, one or more embodiments of the present invention will be described with reference to the drawings. However, the scope of the invention is not limited to the disclosed embodiments.

### First Embodiment

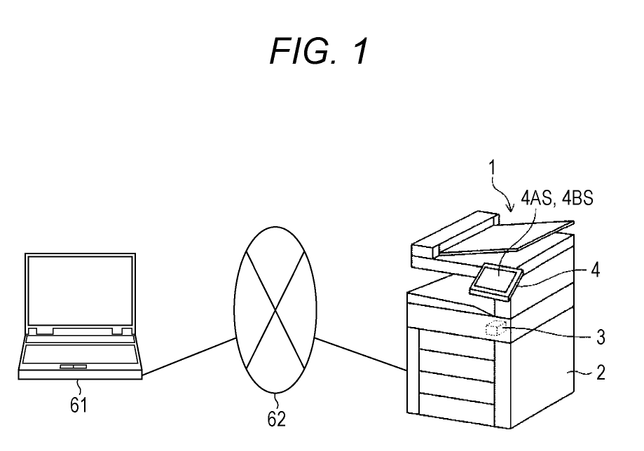

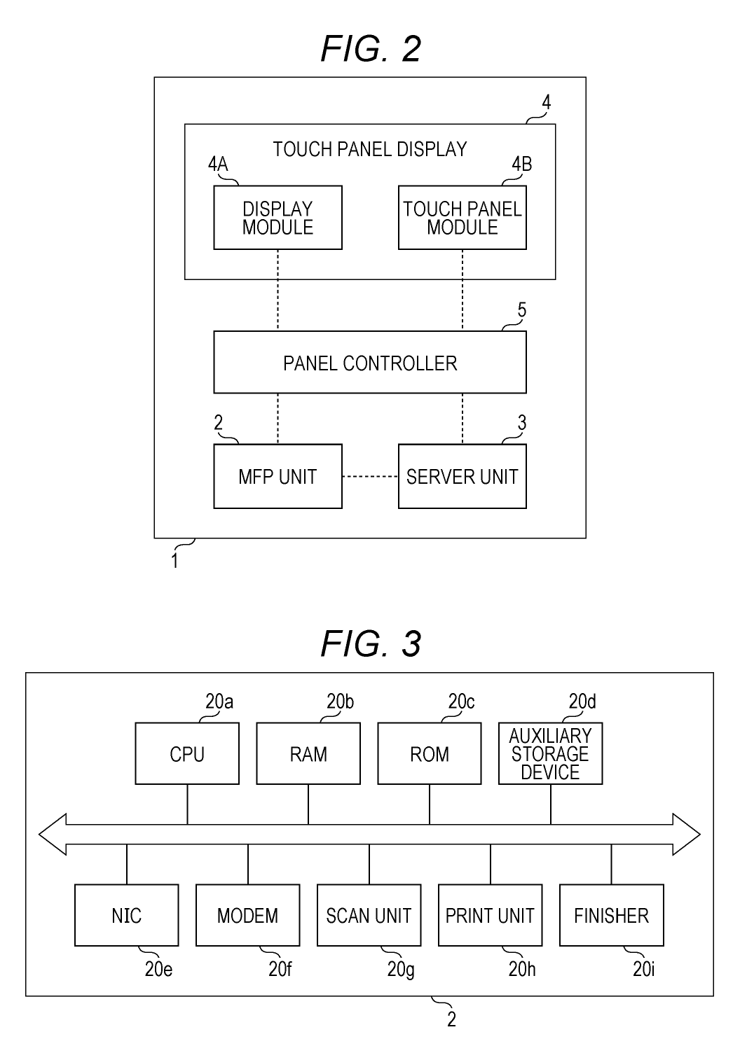

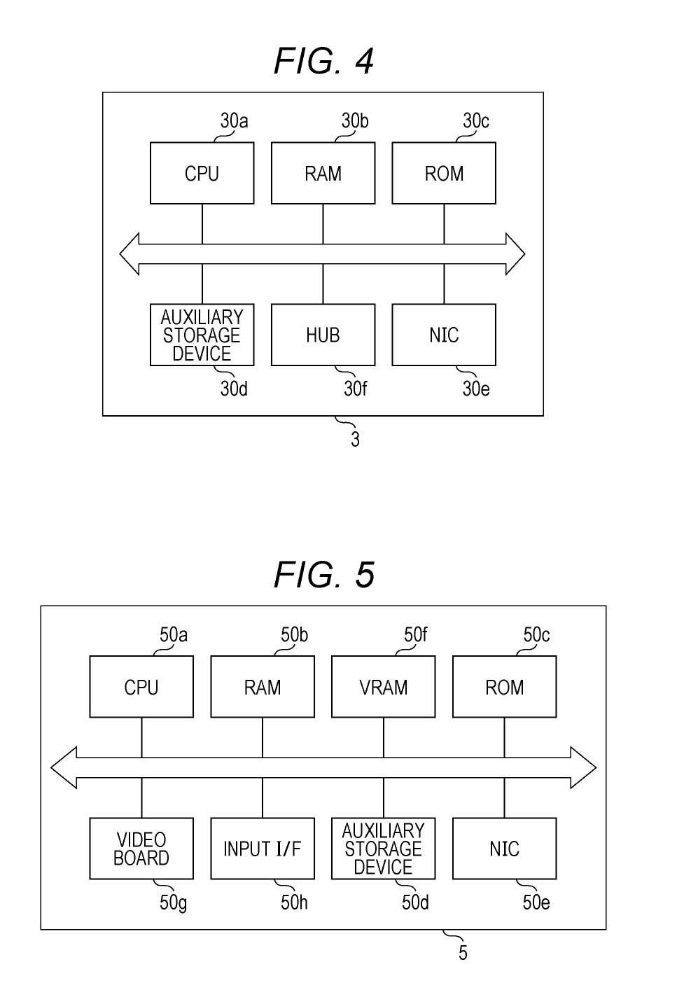

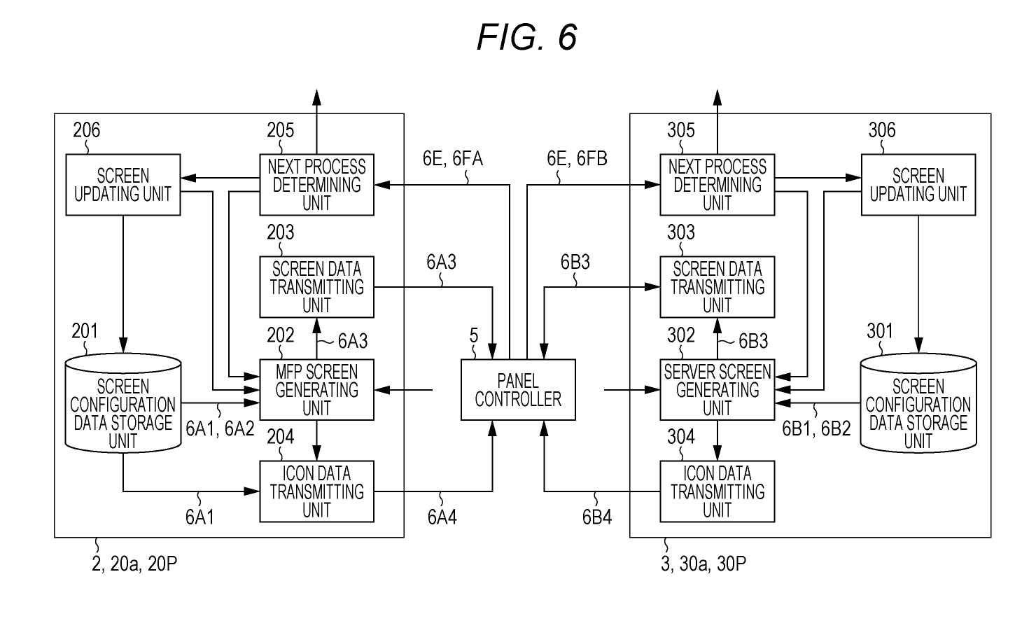

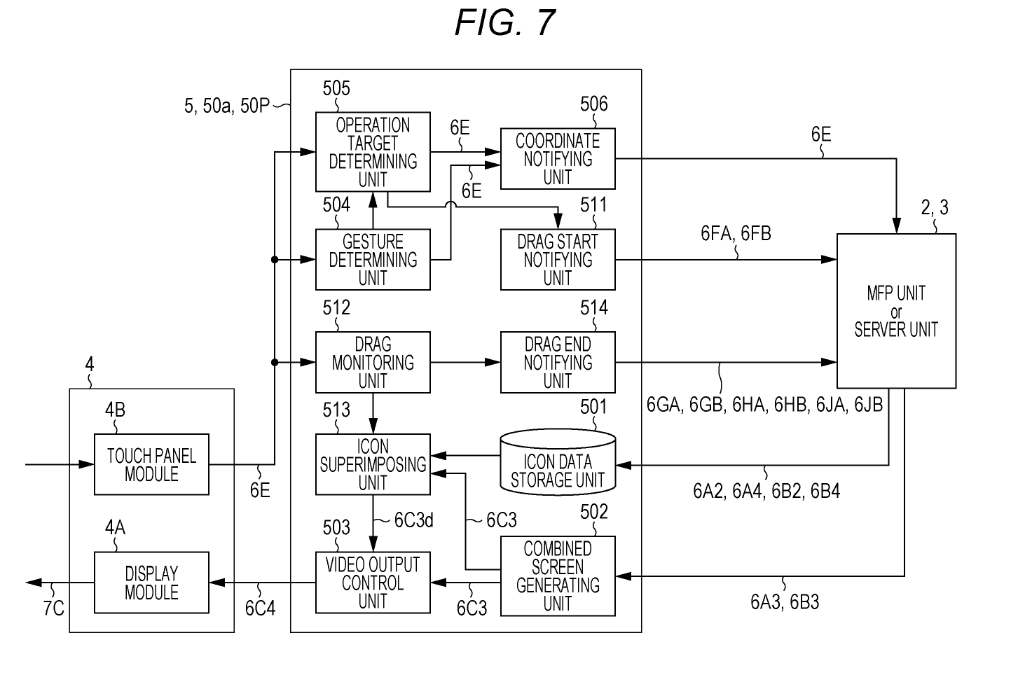

FIG. 1 is a diagram showing an example of a network system including a multi function peripheral 1. FIG. 2 is a diagram showing an example hardware configuration of the multi function peripheral 1. FIG. 3 is a diagram showing an example hardware configuration of an MFP unit 2. FIG. 4 is a diagram showing an example hardware configuration of a server unit 3. FIG. 5 is a diagram showing an example hardware configuration of a panel controller 5. FIG. 6 is a diagram showing example functional configurations of the MFP unit 2 and the server unit 3. FIG. 7 is a diagram showing an example functional configuration of the panel controller 5.

The multi function peripheral 1 shown in FIG. 1 is an apparatus in which various functions are provided. The multi function peripheral 1 can communicate with a terminal device 61 or the like via a communication line 62. The communication line 62 may be the Internet, a local area network (LAN) line, a dedicated line, or the like.

As shown in FIG. 2, the multi function peripheral 1 includes an MFP unit 2, a server unit 3, a touch panel display 4, and a panel controller 5.

The server unit 3 is housed in the casing of the MFP unit 2. The touch panel display 4 is disposed on the front surface of the casing of the multi function peripheral 1 so that the display surface and the touch surface are substantially horizontal.

The MFP unit 2 is an apparatus equivalent to an image forming apparatus generally called “multi function peripherals (MFP)”, and has functions such as copy, PC print, facsimile, scan, and box functions.

The PC print function is a function of printing an image on a paper sheet in accordance with image data received from a device outside the multi function peripheral 1 or from the server unit 3.

The box function is a function for allocating a storage area called a “box” or a “personal box” to each user, and allowing each user to store and manage image data and the like in his/her own storage area. A box corresponds to a “folder” or a “directory” in a personal computer.

The server unit 3 is a device corresponding to a server device or a personal computer, and has the functions of a web server or a file transfer protocol (FTP) server. The server unit 3 is an embedded computer (such as embedded Linux (registered trademark) or embedded Windows (registered trademark)). An embedded computer is also sometimes called an “embedded computer system” or a “built-in server”.

The touch panel display 4 is shared by the MFP unit 2 and the server unit 3. For users who directly operate the multi function peripheral 1, the screen of the MFP unit 2 and the screen of the server unit 3 are displayed side by side on a display surface 4AS. Further, data indicating the coordinates of a touched position on a touch surface 4BS is transmitted to the panel controller 5.

The panel controller 5 is a computer for coordinating the MFP unit 2 and the server unit 3 with the touch panel display 4. The panel controller 5 converts screen data that are received from the MFP unit 2 or the server unit 3 and is designed for displaying a screen into a video signal, and transmits the video signal to the touch panel display 4. Alternatively, the panel controller 5 generates a combined screen by arranging the screens of the MFP unit 2 and the server unit 3 side by side, and transmits a video signal for displaying the combined screen to the touch panel display 4. The panel controller 5 also transmits the coordinate data received from the touch panel display 4 to the MFP unit 2 or the server unit 3.

Basic services are provided to users through the respective functions of the MFP unit 2 and the server unit 3. Further, applied services are provided to users through combinations of those functions.

As shown in FIG. 3, the MFP unit 2 includes a central processing unit (CPU) 20a, a random access memory (RAM) 20b, a read only memory (ROM) 20c, an auxiliary storage device 20d, a network interface card (NIC) 20e, a modem 20f, a scan unit 20g, a print unit 20h, and a finisher 20i.

The NIC 20e is connected to a hub 30f (see FIG. 4) of the server unit 3 with a twisted pair cable, and communicates with the server unit 3 or the panel controller 5 by a protocol such as TCP/IP (Transmission Control Protocol/Internet Protocol). The NIC 20e further communicates with a device outside the multi function peripheral 1, such as the terminal device 61 or a server on the Internet, via the hub 30f.

The modem 20f exchanges image data with a facsimile terminal by a protocol such as G3.

The scan unit 20g reads an image drawn/written on a paper sheet set on the platen glass, and then generates image data.

The print unit 20h prints, on a paper sheet, the image indicated by image data received from a device outside the multi function peripheral 1 or from the server unit 3, in addition to an image read by the scan unit 20g.

The finisher 20i subjects a printed material obtained by the print unit 20h to post-processing as necessary. The post-processing is a binding process with staples, a punch hole opening process, a folding process, or the like.

The CPU 20a is the main CPU of the MFP unit 2. The RAM 20b is the main memory of the MFP unit 2.

The ROM 20c or the auxiliary storage device 20d stores not only the operating system but also applications for achieving the above described functions such as the copy function and providing services. Further, a client program 20P (see FIG. 6) is stored. The client program 20P is a program for receiving a service sharing the touch panel display 4 with the server unit 3.

These programs are loaded into the RAM 20b, and are executed by the CPU 20a. The auxiliary storage device 20d is a hard disk drive, a solid state drive (SSD), or the like.

As shown in FIG. 4, the server unit 3 includes a CPU 30a, a RAM 30b, a ROM 30c, an auxiliary storage device 30d, a NIC 30e, and the hub 30f.

The NIC 30e is connected to the hub 30f with a cable, and communicates with a device outside the multi function peripheral 1 as well as the MFP unit 2 and the panel controller 5 via the hub 30f by a protocol such as TCP/IP.

As described above, the NIC 30e and the NIC 20e of the MFP unit 2 are connected to the hub 30f with cables. Further, the hub 30f is connected to a router and an NIC 50e (see FIG. 5) of the panel controller 5 with cables. With this arrangement, the hub 30f relays data to be exchanged between these devices.

The CPU 30a is the main CPU of the server unit 3. The RAM 30b is a main memory of the server unit 3.

The ROM 30c or the auxiliary storage device 30d stores not only the operating system but also programs such as applications for achieving the above described functions and providing services. Further, a client program 30P (see FIG. 6) is stored. The client program 30P is a program for receiving a service sharing the touch panel display 4 with the MFP unit 2.

These programs are loaded into the RAM 30b, and are executed by the CPU 30a. The auxiliary storage device 30d is a hard disk drive, an SSD, or the like.

As shown in FIG. 2, the touch panel display 4 is formed with a display module 4A, a touch panel module 4B, and the like.

The display module 4A displays a screen in accordance with the video signal transmitted from the panel controller 5. The display module 4A is a flat panel display such as an organic electro luminescence (EL) display or a liquid crystal display.

Every time the touch panel module 4B detects that the touch surface 4BS is touched, the touch panel module 4B transmits data indicating the coordinates of the touched position to the panel controller 5.

As shown in FIG. 5, the panel controller 5 includes a CPU 50a, a RAM 50b, a ROM 50c, an auxiliary storage device 50d, the NIC 50e, a video RAM (VRAM) 50f, a video board 50g, and an input interface 50h.

The NIC 50e is connected to the hub 30f (see FIG. 4) of the server unit 3 with a twisted pair cable, and communicates with the MFP unit 2 or the server unit 3 by a protocol such as TCP/IP.

The VRAM 50f is a graphic memory for storing the screen data of the screen to be displayed on the touch panel display 4.

The video board 50g converts the screen data into a video signal, and transmits the video signal to the display module 4A. The video board 50g is sometimes also referred to as a “graphic board”, a “liquid crystal display (LCD) controller” or a “video card”. In some cases, the VRAM 50f is incorporated into the video board 50g.

A high-definition multimedia interface (HDMI) (registered trademark), a D-subminiature (D-SUB), or the like is used as an interface of the video board 50g.

The input interface 50h is connected to the touch panel module 4B with a cable, and a signal is input thereto from the touch panel module 4B.

IEEE 1394, a universal serial bus (USB), or the like is used as an interface of the input interface 50h.

The operating system and the like are stored in the ROM 50c or the auxiliary storage device 50d. A relay program 50P (see FIG. 7) is also stored. The relay program 50P is a program for performing a process of combining the screen of the MFP unit 2 and the screen of the server unit 3 and transmitting the combined screen as a video signal to the display module 4A, and a process of correcting data input from the touch panel module 4B and transmitting the corrected data to the MFP unit 2 or the server unit 3.

These programs are loaded into the RAM 50b as necessary, and are executed by the CPU 50a. The auxiliary storage device 50d is a hard disk drive, an SSD, or the like.

With the client program 20P, a screen configuration data storage unit 201, an MFP screen generating unit 202, a screen data transmitting unit 203, an icon data transmitting unit 204, a next process determining unit 205, a screen updating unit 206, and the like shown in FIG. 6 are formed in the MFP unit 2.

With the client program 30P, a screen configuration data storage unit 301, a server screen generating unit 302, a screen data transmitting unit 303, an icon data transmitting unit 304, a next process determining unit 305, a screen updating unit 306, and the like shown in FIG. 6 are formed in the server unit 3.

With the relay program 50P, an icon data storage unit 501, a combined screen generating unit 502, a video output control unit 503, a gesture determining unit 504, an operation target determining unit 505, a coordinate notifying unit 506, a drag start notifying unit 511, a drag monitoring unit 512, an icon superimposing unit 513, a drag end notifying unit 514, and the like shown in FIG. 7 are formed in the panel controller 5.

In the description below, the respective components of the MFP unit 2 and the respective components of the server unit 3 shown in FIG. 6, and the respective components of the panel controller 5 shown in FIG. 7 will be roughly divided into a process for displaying a combined screen and a process for responding to a touch.

[Display of a Combined Screen]

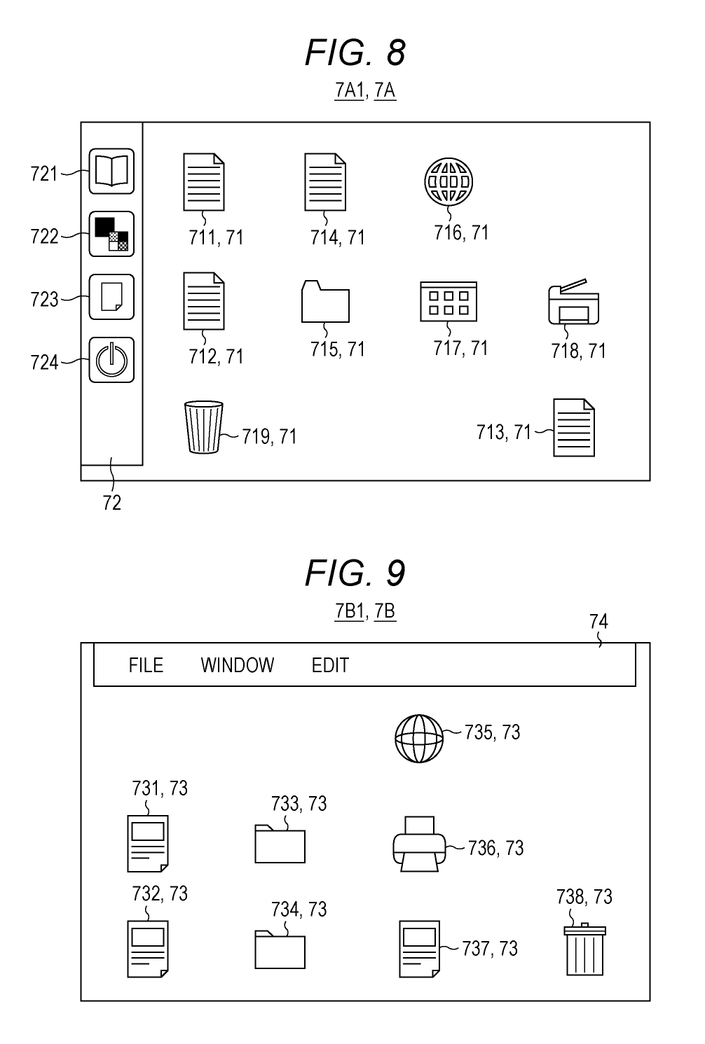

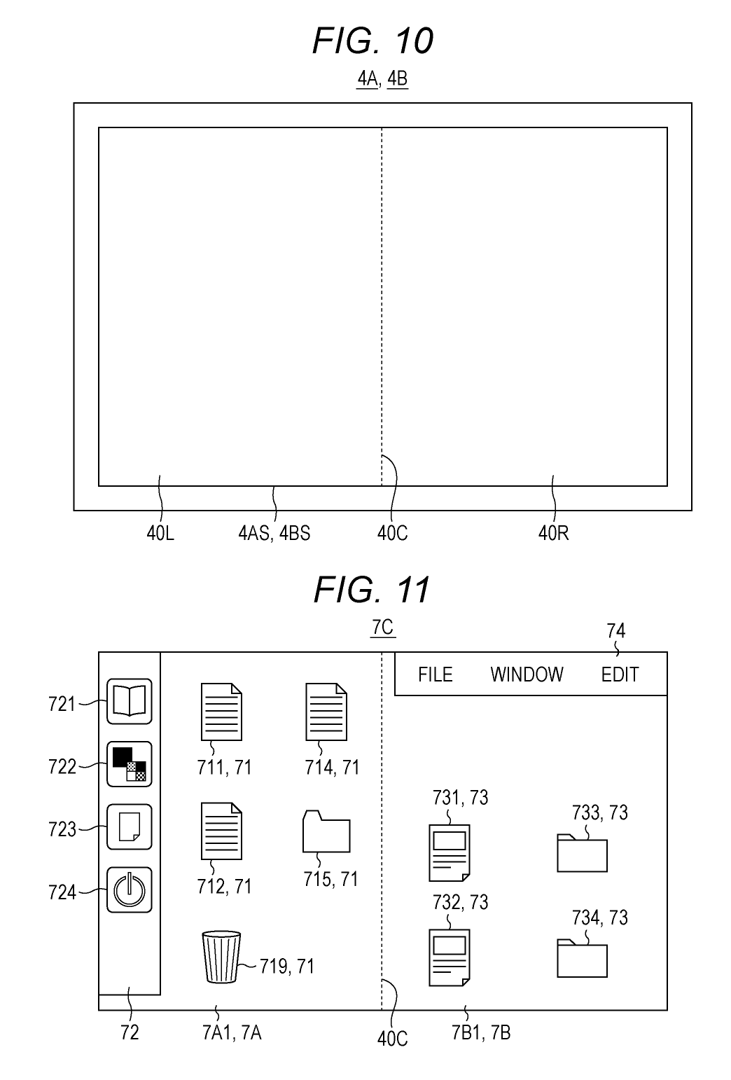

FIG. 8 is a diagram showing an example of a desktop screen 7A1. FIG. 9 is a diagram showing an example of a desktop screen 7B1. FIG. 10 is a diagram showing an example of the display surface 4AS and the touch surface 4BS. FIG. 11 is a diagram showing an example of a combined screen 7C.

In the MFP unit 2, for each MFP screen 7A that is a screen for a user to operate the MFP unit 2, screen configuration data 6A1 indicating the positions and the identifiers of the respective objects constituting the MFP screen 7A is stored beforehand in the screen configuration data storage unit 201. A “position” is the position of an object on the MFP screen 7A. In this embodiment, the coordinates of the four vertexes of the smallest rectangle that can enclose the object are shown as the position of the object.

Further, image data 6A2 for each object is associated with an identifier and is stored beforehand in the screen configuration data storage unit 201.

An example of an object is an icon 71 or a menu bar 72. For example, as shown in FIG. 8, a menu bar 72 and nine icons 71 are arranged on a desktop screen 7A1 that is an MFP screen 7A. Hereinafter, the icons 71 arranged on the desktop screen 7A1 will be distinguished as follows: “icon 711”, “icon 712”, . . . , and “icon 719”.

In this embodiment, the sizes (vertical and horizontal lengths) of the respective MFP screens 7A are determined in advance, and are the same as the size of the display surface 4AS of the display module 4A. The same applies to the server screens 7B described later. Further, for ease of explanation, an example case where the resolution of the display surface 4AS is the same as the resolution of the touch surface 4BS of the touch panel module 4B is described herein. On the display surface 4AS, the touch surface 4BS, and any of the screens described later, the vertex at the upper left is the origin, the longitudinal axis is the Y-axis, and the horizontal direction is the X-axis.

The MFP screen generating unit 202 generates screen data 6A3 for causing the display module 4A to display the entire MFP screen 7A, in accordance with the screen configuration data 6A1 of the MFP screen 7A and the image data 6A2 of the respective objects constituting the MFP screen 7A.

The format of the screen data 6A3 is a bitmap, for example. Alternatively, the format of the screen data 6A3 may be the graphics interchange format (GIF), the Joint Photographic Experts Group (JPEG) format, or the like. The MFP screen generating unit 202 may also generate moving image data as the screen data 6A3 by drawing an MFP screen 7A at a predetermined frame rate. The same applies to the screen data 6B3 that will be described later.

The screen configuration data 6A1 and the image data 6A2 are read from the screen configuration data storage unit 201.

The screen data transmitting unit 203 transmits the screen data 6A3 generated by the MFP screen generating unit 202 to the panel controller 5. In a case where the screen data 6A3 is moving image data, the screen data 6A3 is transmitted by live streaming.

When transmission of the screen data 6A3 of the MFP screen 7A is newly started by the screen data transmitting unit 203, the icon data transmitting unit 204 transmits the image data 6A2 and the area data 6A4 of each icon 71 on the MFP screen 7A to the panel controller 5. The image data 6A2 is read from the screen configuration data storage unit 201.

In the area data 6A4 of an icon 71, the identifier of the icon 71 is shown. Further, the coordinates of the four vertexes of the smallest rectangle that can surround the icon 71 are shown as the area in which the icon 71 is placed on the MFP screen 7A. These coordinates are the same as the four sets of coordinates of the icon 71 indicated by the screen configuration data 6A1 of the MFP screen 7A stored in the screen configuration data storage unit 201.

For example, when transmission of the screen data 6A3 of the desktop screen 7A1 is newly started, the icon data transmitting unit 204 transmits the image data 6A2 and the area data 6A4 of the respective icons 71 (the icons 711 through 719 in FIG. 8) on the desktop screen 7A1 to the panel controller 5. After that, when transmission of the screen data 6A3 of another MFP screen 7A is newly started, the icon data transmitting unit 204 transmits the image data 6A2 and the area data 6A4 of each icon 71 on this MFP screen 7A to the panel controller 5. When transmission of the screen data 6A3 of the desktop screen 7A1 is again newly started, the icon data transmitting unit 204 transmits the image data 6A2 and the area data 6A4 of each icon 71 on the desktop screen 7A1 to the panel controller 5.

In the server unit 3, for each server screen 7B that is a screen for a user to operate the server unit 3, screen configuration data 6B1 indicating the positions and the identifiers of the respective objects constituting the server screen 7B is stored beforehand in the screen configuration data storage unit 301. A “position” is the position of an object on the server screen 7B. In this embodiment, the coordinates of the four vertexes of the smallest rectangle that can enclose the object are shown as the position of the object.

Further, image data 6B2 for each object is associated with an identifier and is stored beforehand in the screen configuration data storage unit 301.

On the server screen 7B, a menu bar 74, icons 73, and the like are arranged as objects.

For example, as shown in FIG. 9, the menu bar 74 and eight icons 73 are arranged on a desktop screen 7B1 that is a server screen 7B. Hereinafter, the icons 73 will be distinguished as follows: “icon 731”, “icon 732”, . . . , and “icon 738”.

The server screen generating unit 302 generates screen data 6B3 for causing the display module 4A to display the server screen 7B, in accordance with the screen configuration data 6B1 of the server screen 7B and the image data 6B2 of the respective objects constituting the server screen 7B. The screen configuration data 6B1 and the image data 6B2 are read from the screen configuration data storage unit 301.

The screen data transmitting unit 303 transmits the screen data 6B3 generated by the server screen generating unit 302 to the panel controller 5. In a case where the screen data 6B3 is moving image data, the screen data 6B3 is transmitted by live streaming.

When transmission of the screen data 6B3 of the server screen 7B is newly started by the screen data transmitting unit 303, the icon data transmitting unit 304 transmits the image data 6B2 and the area data 6B4 of each icon 73 on the server screen 7B to the panel controller 5. The image data 6B2 is read from the screen configuration data storage unit 301.

In the area data 6B4 of an icon 73, the identifier of the icon 73 is shown. Further, the coordinates of the four vertexes of the smallest rectangle that can surround the icon 73 are shown as the area in which the icon 73 is placed on the server screen 7B. These coordinates are the same as the four sets of coordinates of the icon 73 indicated by the screen configuration data 6B1 of the server screen 7B stored in the screen configuration data storage unit 301.

For example, when transmission of the screen data 6B3 of the desktop screen 7B1 is newly started, the icon data transmitting unit 304 transmits the image data 6B2 and the area data 6B4 of the respective icons 73 (the icons 731 through 738 in FIG. 9) on the desktop screen 7B1 to the panel controller 5. After that, when transmission of the screen data 6B3 of another server screen 7B is newly started, the icon data transmitting unit 304 transmits the image data 6B2 and the area data 6B4 of each icon 73 on this server screen 7B to the panel controller 5. When transmission of the screen data 6B3 of the desktop screen 7B1 is again newly started, the icon data transmitting unit 304 transmits the image data 6B2 and the area data 6B4 of each icon 73 on the desktop screen 7B1 to the panel controller 5.

Meanwhile, the display surface 4AS of the display module 4A and the touch surface 4BS of the touch panel module 4B are divided into right and left regions by a boundary 40C, as shown in FIG. 10. The left region 40L, which is the region on the left side, is used, in principle, for display or operation of the MFP screen 7A. The right region 40R, which is the region on the right side, is used, in principle, for display or operation of the server screen 7B.

Hereinafter, the MFP screen 7A displayed in the left region 40L will be referred to as the “current MFP screen”, and the server screen 7B displayed in the right region 40R will be referred to as the “current server screen”.

In the panel controller 5, the icon data storage unit 501 stores image data 6A2 and area data 6A4 transmitted from the MFP unit 2, and image data 6B2 and area data 6B4 transmitted from the server unit 3.

Every time the current MFP screen changes, image data 6A2 and area data 6A4 are newly transmitted from the MFP unit 2. The old image data 6A2 and the old area data 6A4 are then deleted from the icon data storage unit 501, and the new image data 6A2 and the new area data 6A4 are stored into the icon data storage unit 501.

For example, when the desktop screen 7A1 is displayed as the current MFP screen at the time of activation of the operating system of the MFP unit 2, the image data 6A2 and the area data 6A4 of the respective objects of the desktop screen 7A1 are transmitted from the MFP unit 2, and are stored into the icon data storage unit 501. After that, when an MFP screen 7A showing the contents of a trash box, instead of the desktop screen 7A1, is displayed as the current MFP screen, the image data 6A2 and the area data 6A4 of the respective objects of the MFP screen 7A are newly transmitted from the MFP unit 2. The image data 6A2 and the area data 6A4 of the respective objects of the desktop screen 7A1 are then deleted from the icon data storage unit 501, and the newly transmitted image data 6A2 and area data 6A4 are stored into the icon data storage unit 501 of the MFP unit 2.

Likewise, every time the current server screen changes, image data 6B2 and area data 6B4 are newly transmitted from the MFP unit 2. The old image data 6B2 and the old area data 6B4 are then deleted from the icon data storage unit 501, and the new image data 6B2 and the new area data 6B4 are stored into the icon data storage unit 501.

The combined screen generating unit 502 generates the screen data 6C3 of a combined screen 7C, in accordance with screen data 6A3 received from the MFP unit 2 and screen data 6B3 received from the server unit 3. As shown in FIG. 11, a combined screen 7C is formed with the left halves of an MFP screen 7A and a server screen 7B.

After the screen data 6C3 is generated by the combined screen generating unit 502, the video output control unit 503 causes the video board 50g to perform a process of converting the screen data 6C3 into a video signal 6C4 and output the video signal 6C4 to the display module 4A.

The display module 4A then displays the combined screen 7C in accordance with the video signal 6C4.

[Process for Responding to a Touch]

A user performs a gesture such as a tap, a double tap, a pinch-in, a pinch-out, or a drag by touching the touch surface 4BS. Hereinafter, a gesture performed on the touch surface 4BS by a user will be referred to as a “user gesture”.

While the touch surface 4BS is being touched, the touch panel module 4B transmits, to the panel controller 5, coordinate data 6E indicating the coordinates of the touched position at regular intervals of 0.1 seconds, for example.

In the panel controller 5, when reception of the coordinate data 6E is started, the gesture determining unit 504 determines whether the user gesture is a drag by a known method, in accordance with the received coordinate data 6E.

If the user gesture is determined to be a drag, the operation target determining unit 505 determines the target of the drag as follows.

If the coordinates indicated by the first coordinate data 6E are the coordinates on the left side of the boundary 40C, the operation target determining unit 505 reads area data 6A4 from the combined screen generating unit 502. The operation target determining unit 505 then compares the coordinates indicated by the coordinate data 6E with the respective areas indicated by the read area data 6A4, to determine to which one of the areas the coordinates belong. The operation target determining unit 505 then determines that the icon 71 corresponding to the area to which the coordinates belong is the target of the drag. If the coordinates do not belong to any of the areas, the operation target determining unit 505 determines that an object other than the icons 71 is the target of the drag.

If the coordinates indicated by the coordinate data 6E are the coordinates on the right side of the boundary 40C, the operation target determining unit 505 reads area data 6B4 from the combined screen generating unit 502. The coordinates indicated in the coordinate data 6E are based on the origin of the touch surface 4BS. Therefore, the coordinates are corrected so as to be based on the origin of the server screen 7B. In this embodiment, the coordinates are shifted to the left by the amount equivalent to the width of the left region 40L. That is, the width of the left region 40L is subtracted from the value of the X-coordinate of the coordinates. Hereinafter, such a process of correcting coordinates on the touch surface 4BS to become coordinates on the server screen 7B will be referred to as a “shift process”.

The operation target determining unit 505 compares the coordinates subjected to the shift process with the respective areas indicated by the read area data 6B4, to determine which one of those areas the coordinates belong. The operation target determining unit 505 then determines that the icon 73 corresponding to the area to which the coordinates belong is the target of the drag. If the coordinates do not belong to any of the areas, the operation target determining unit 505 determines that an object other than the icons 73 is the target of the drag.

If the coordinates indicated by the first coordinate data 6E are coordinates on the left side of the boundary 40C, and the target of the drag is determined to be an object other than the icons 71 by the operation target determining unit 505, the coordinate notifying unit 506 transfers the coordinate data 6E transmitted from the touch panel module 4B to the MFP unit 2. Likewise, in a case where the gesture determining unit 504 determines that the user gesture is not a drag, the coordinate data 6E is also transferred to the MFP unit 2.

If the coordinates indicated by the first coordinate data 6E are coordinates on the right side of the boundary 40C, and the target of the drag is determined to be an object other than the icons 73 by the operation target determining unit 505, the coordinate notifying unit 506 performs a shift process on the coordinate data 6E transmitted from the touch panel module 4B, and transfers the resultant coordinate data 6E to the server unit 3. Likewise, in a case where the gesture determining unit 504 determines that the user gesture is not a drag, the coordinate data 6E is also subjected to a shift process and is transferred to the server unit 3.

The process to be performed in a case where the operation target determining unit 505 determines that the target of the drag is an icon 71 or an icon 73 will be described later.

In the MFP unit 2, the next process determining unit 205 determines the process to be performed next (this process will be hereinafter referred to as the “next process”), in accordance with data transmitted from the panel controller 5.

In a case where coordinate data 6E is transmitted thereto, the next process determining unit 205 determines the user gesture by a known method, in accordance with the coordinate data 6E. The next process determining unit 205 further identifies the object that is the target of the user gesture, in accordance with the screen configuration data 6A1 of the current MFP screen. The next process determining unit 205 then determines the next process, in accordance with the determined user gesture and the identified object.

For example, in a case where the current MFP screen is the desktop screen 7A1 (see FIG. 8), the user gesture is a tap, and the identified object is the icon 719, the next process determining unit 205 determines the next process to be a process of displaying an MFP screen 7A showing the contents of the trash box. In a case where the identified object is a button 724 in the menu bar 72, the next process is determined to be shutting down the operating system.

The next process determined by the next process determining unit 205 is then performed in the MFP unit 2. For example, in a case where the next process is determined to be a process of displaying the MFP screen 7A showing the contents of the trash box, the MFP screen generating unit 202 and the screen data transmitting unit 203 perform a process of causing the display module 4A to display the MFP screen 7A as the current MFP screen. In a case where the next process is determined to be a process of shutting down the operating system, the operating system is shut down.

In the server unit 3, the next process determining unit 305 also determines the next process in accordance with coordinate data 6E transmitted from the panel controller 5, like the next process determining unit 205. In this case, however, the object that is the target of the user gesture is identified in accordance with the screen configuration data 6B1 of the current server screen.

The next process determined by the next process determining unit 305 is then performed in the server unit 3.

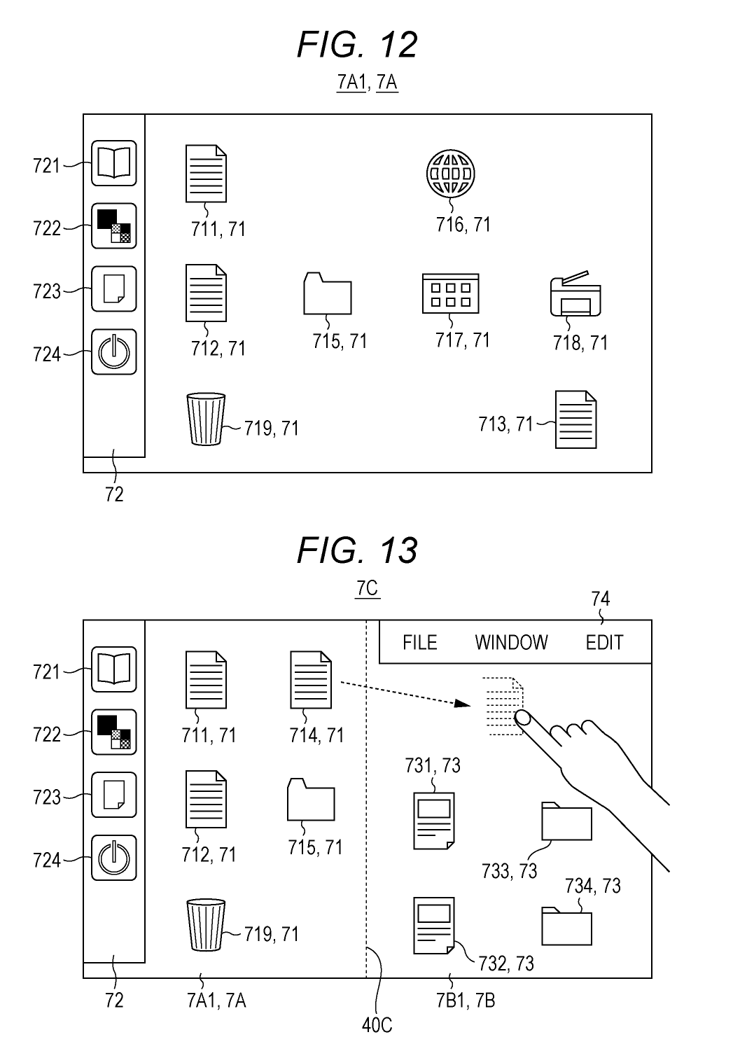

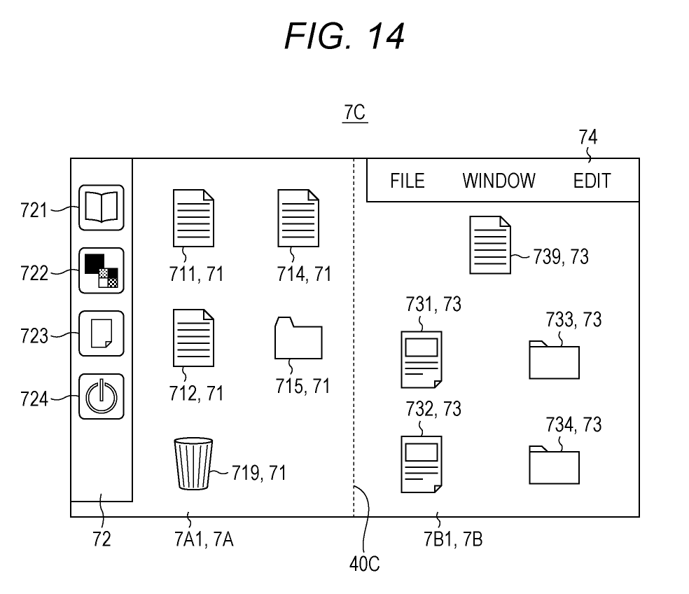

FIG. 12 is a diagram showing an example of the desktop screen 7A1 excluding the icon 714. FIG. 13 is a diagram showing an example of a drag of the icon 714. FIG. 14 is a diagram showing an example of a combined screen 7C in a state where the icon 714 is dropped.

In a case where the operation target determining unit 505 determines that the target of a drag is an icon 71 or an icon 73, a process for moving the icon 71 or the icon 73 according to the drag is performed as described below. Hereinafter, the icon 71 or the icon 73, which is the target of the drag, will be referred to as the “selected icon”.

In a case where one of the icons 71 is the selected icon, the drag start notifying unit 511 transmits start notification data 6FA indicating the identifier of the selected icon to the MFP unit 2, to notify the MFP unit 2 that the selected icon has started to be dragged.

On the other hand, in a case where one of the icons 73 is the selected icon, the drag start notifying unit 511 transmits start notification data 6FB indicating the identifier of the selected icon to the server unit 3, to notify the server unit 3 that the selected icon has started to be dragged.

The drag monitoring unit 512 monitors the touched position on the touch surface 4BS by monitoring the coordinates indicated by coordinate data 6E sequentially transmitted from the panel controller 5. That is, the drag monitoring unit 512 monitors changes in the drag. Hereinafter, the touched position on the touch surface 4BS will be referred to as the “touch position”.

In the MFP unit 2, upon receipt of the start notification data 6FA, the next process determining unit 205 determines that the next process is a process of updating the current MFP screen to drag an icon.

The MFP screen generating unit 202 then regenerates the screen data 6A3 of the current MFP screen, excluding the icon 71 of the identifier indicated in the start notification data 6FA. The screen data transmitting unit 203 then transmits the screen data 6A3 to the panel controller 5.

For example, in a case where the current MFP screen is the desktop screen 7A1 (see FIG. 8), and the start notification data 6FA indicates the identifier of the icon 714, the MFP screen generating unit 202 generates the screen data 6A3 of a screen excluding the icon 714 as shown in FIG. 12, and the screen data transmitting unit 203 transmits the screen data 6A3 to the panel controller 5.

Likewise, in the server unit 3, upon receipt of the start notification data 6FB, the next process determining unit 305 determines that the next process is a process of updating the current server screen to drag an icon.

The server screen generating unit 302 then regenerates the screen data 6B3 of the current server screen, excluding the icon 73 of the identifier indicated by the start notification data 6FB. The screen data transmitting unit 303 then transmits the screen data 6B3 to the panel controller 5.

In the panel controller 5, the combined screen generating unit 502 generates the screen data 6C3 of a combined screen 7C in accordance with the screen data 6A3 received from the MFP unit 2 and the screen data 6B3 received from the server unit 3, as described above.

However, in a case where the selected icon is an icon 71, the selected icon is excluded from the MFP screen 7A reproduced with the screen data 6A3, as shown in FIG. 12. In a case where the selected icon is an icon 73, the selected icon is excluded from the server screen 7B reproduced with the screen data 6B3.

Therefore, while the touch position is being monitored by the drag monitoring unit 512, the icon superimposing unit 513 and the video output control unit 503 perform processes as follows.

The icon superimposing unit 513 updates the screen data 6C3 so that the selected icon overlaps with the position of the same coordinates as the coordinates of the latest touch position on the combined screen 7C.

The video output control unit 503 causes the video board 50g to convert the screen data 6C3 updated by the icon superimposing unit 513 into a video signal 6C4 and output the video signal 6C4 to the display module 4A.

The display module 4A then displays the combined screen 7C in accordance with the video signal 6C4.

The touch position changes with time. Therefore, through the processes performed by the icon superimposing unit 513 and the video output control unit 503, the selected icon moves on the combined screen 7C as the touch position changes. In some cases, the selected icon crosses the boundary 40C as shown in FIG. 13.

When the transmission of the coordinate data 6E from the panel controller 5 stops, the drag monitoring unit 512 determines that the drag has ended, and ends the monitoring of the touch position. Thus, the movement of the selected icon ends.

After the drag monitoring unit 512 ends the monitoring of the touch position, the drag end notifying unit 514 performs a process of notifying the MFP unit 2 or the server unit 3 of the end of the drag as described below.

In a case where the monitoring ends without the touch position crossing the boundary 40C, and the selected icon is of the current MFP screen, the drag end notifying unit 514 transmits first end notification data 6GA to the MFP unit 2. The first end notification data 6GA indicates the touch position immediately before the end of the monitoring, or the coordinates of the position at which the finger is removed from the screen. In a case where the selected icon is of the current server screen, on the other hand, first end notification data 6GB is transmitted to the server unit 3. The first end notification data 6GB indicates the coordinates of a position on the current server screen, the position corresponding to the touch position immediately before the end of the monitoring.

In a case where the monitoring ends after the touch position crosses the boundary 40C from the left region 40L and enters the right region 40R, the drag end notifying unit 514 transmits second end notification data 6HA to the MFP unit 2, and transmits entry notification data 6HB to the server unit 3.

The second end notification data 6HA indicates the identifier of the selected icon. The entry notification data 6HB indicates the coordinates of a position on the current server screen, the position corresponding to the touch position immediately before the end of the monitoring. The entry notification data 6HB further includes the image data 6A2 of the selected icon.

In a case where the monitoring ends after the touch position crosses the boundary 40C from the right region 40R and enters the left region 40L, on the other hand, the drag end notifying unit 514 transmits entry notification data 6JA to the MFP unit 2, and transmits second end notification data 6JB to the server unit 3.

The entry notification data 6JA indicates the coordinates of the touch position immediately before the end of the monitoring. The entry notification data 6JA further includes the image data 6B2 of the selected icon. The second end notification data 6JB indicates the identifier of the selected icon.

In a case where the first end notification data 6GA is received in the MFP unit 2, the next process determining unit 205 determines the next process to be a process of moving the selected icon to the position of the coordinates indicated by the first end notification data 6GA.

The screen updating unit 206 then updates the screen configuration data 6A1 of the current MFP screen stored in the screen configuration data storage unit 201 so that the selected icon is placed at the position. The MFP screen generating unit 202 regenerates the screen data 6A3 of the current MFP screen in accordance with the updated screen configuration data 6A1, and the screen data transmitting unit 203 transmits the screen data 6A3 to the panel controller 5.

In the panel controller 5, the screen data 6C3 of the combined screen 7C is then generated and converted into the video signal 6C4, and the video signal 6C4 is output to the display module 4A, as described above.

In a case where the first end notification data 6GB is received in the server unit 3, the same processes as those in a case where the first end notification data 6GA is received in the MFP unit 2 are performed.

Specifically, the next process determining unit 305 determines the next process to be a process of moving the selected icon to the position of the coordinates indicated by the first end notification data 6GB. The screen updating unit 306 updates the screen configuration data 6B1 of the current server screen stored in the screen configuration data storage unit 301 so that the selected icon is placed at the position. The server screen generating unit 302 regenerates the screen data 6B3 of the current server screen in accordance with the updated screen configuration data 6B1, and the screen data transmitting unit 303 transmits the screen data 6B3 to the panel controller 5.

In the panel controller 5, the screen data 6C3 of the combined screen 7C is then generated and converted into the video signal 6C4, and the video signal 6C4 is output to the display module 4A, as described above.

In a case where the second end notification data 6HA is received in the MFP unit 2, and the entry notification data 6HB is received in the server unit 3, on the other hand, a process for copying a file from the MFP unit 2 into the server unit 3 is performed as described below.

In the MFP unit 2, the next process determining unit 205 determines the next process to be a process of copying the file corresponding to the icon 71 having the identifier indicated by the second end notification data 611A, into the server unit 3.

The file is then transmitted to the server unit 3 by the operating system of the MFP unit 2.

The operating system of the server unit 3 saves the file in the storage area corresponding to the current server screen.

Further, the screen updating unit 306 performs a process for newly adding the icon corresponding to the file as an icon 73 to the current server screen. Specifically, the identifier of the icon is issued, and the coordinates of the four vertexes of the smallest rectangle that can surround the icon are added to the screen configuration data 6B1 of the current server screen so that the icon is placed at the position of the coordinates indicated by the entry notification data 6HB. The image data 6A2 included in the entry notification data 6HB is further associated with the issued identifier and is stored as the image data 6B2 of the icon into the screen configuration data storage unit 301.

The server screen generating unit 302 then regenerates the screen data 6B3 of the current server screen in accordance with the updated screen configuration data 6B1, and the screen data transmitting unit 303 transmits the screen data 6B3 to the panel controller 5.

In turn, in the panel controller 5, the screen data 6C3 of the combined screen 7C is generated and converted into the video signal 6C4, and the video signal 6C4 is output to the display module 4A, as described above.

For example, in a case where the current MFP screen and the current server screen are the desktop screen 7A1 and the desktop screen 7B1, respectively, and the icon 714 is dragged from the desktop screen 7A1 and is dropped on the desktop screen 7B1 across the boundary 40C as shown in FIG. 13, the file corresponding to the icon 714 is transmitted from the MFP unit 2 to the server unit 3.

The file is then stored into the storage area corresponding to the desktop screen 7B1, or into the desktop, and the icon 739 of the file is added as an icon 73 to the desktop screen 7B1.

The screen data 6B3 of the desktop screen 7B1 to which the icon 73 has been added is then transmitted to the panel controller 5, and the combined screen 7C having the icon 73 added thereto as shown in FIG. 14 is displayed on the display module 4A.

In a case where the entry notification data 6JA is received in the MFP unit 2, and the second end notification data 6JB is received in the server unit 3, on the other hand, a process for copying a file from the server unit 3 into the MFP unit 2 is performed as described below.

In the server unit 3, the next process determining unit 305 determines the next process to be a process of copying the file corresponding to the icon 73 having the identifier indicated by the second end notification data 6JB, into the MFP unit 2.

The file is then transmitted to the MFP unit 2 by the operating system of the server unit 3.

The operating system of the MFP unit 2 saves the file in the storage area corresponding to the current MFP screen.

Further, the screen updating unit 206 performs a process for newly adding the icon corresponding to the file as an icon 71 to the current MFP screen. Specifically, the identifier of the icon is issued, and the coordinates of the four vertexes of the smallest rectangle that can surround the icon are added to the screen configuration data 6A1 of the current MFP screen so that the icon is placed at the position of the coordinates indicated by the entry notification data 6JA. The image data 6B2 included in the entry notification data 6JA is further associated with the issued identifier and is stored as the image data 6A2 of the icon into the screen configuration data storage unit 201.

The MFP screen generating unit 202 then regenerates the screen data 6A3 of the current MFP screen in accordance with the updated screen configuration data 6A1, and the screen data transmitting unit 203 transmits the screen data 6A3 to the panel controller 5.

In turn, in the panel controller 5, the screen data 6C3 of the combined screen 7C is generated and converted into the video signal 6C4, and the video signal 6C4 is output to the display module 4A, as described above.

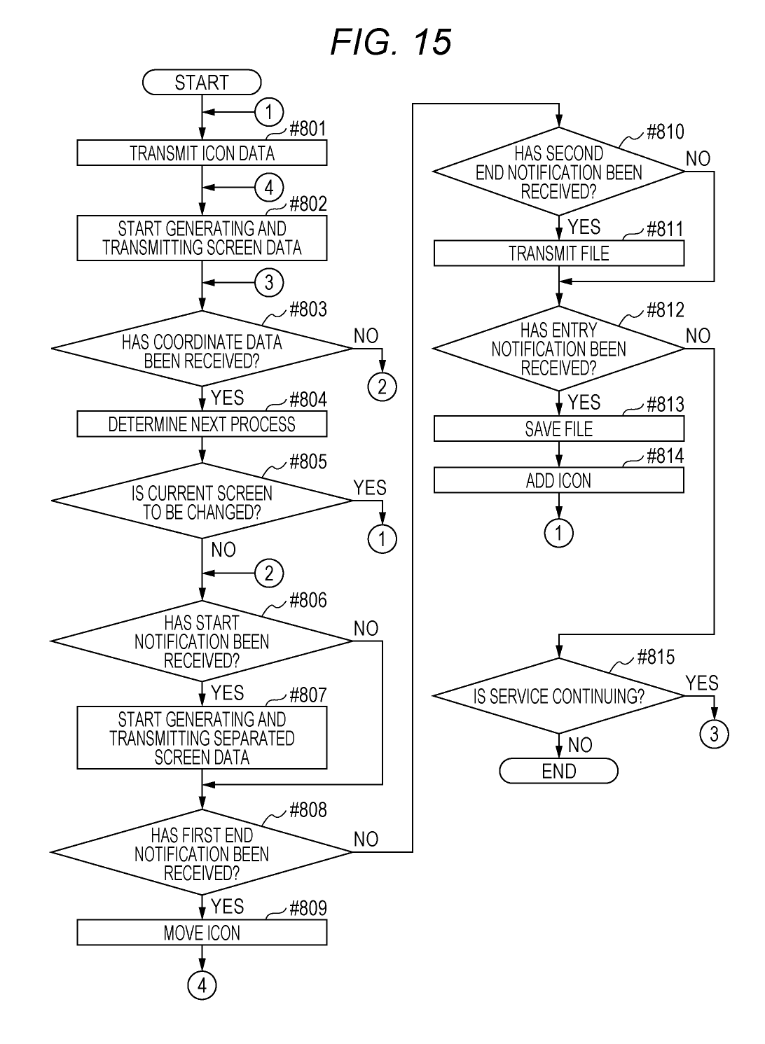

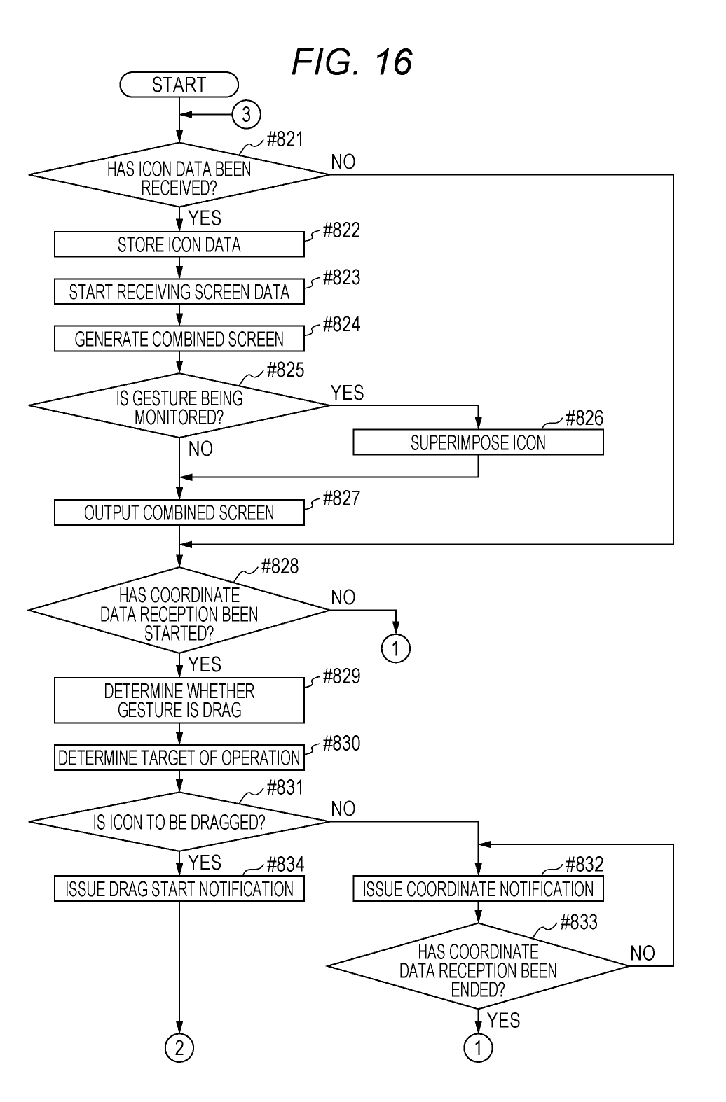

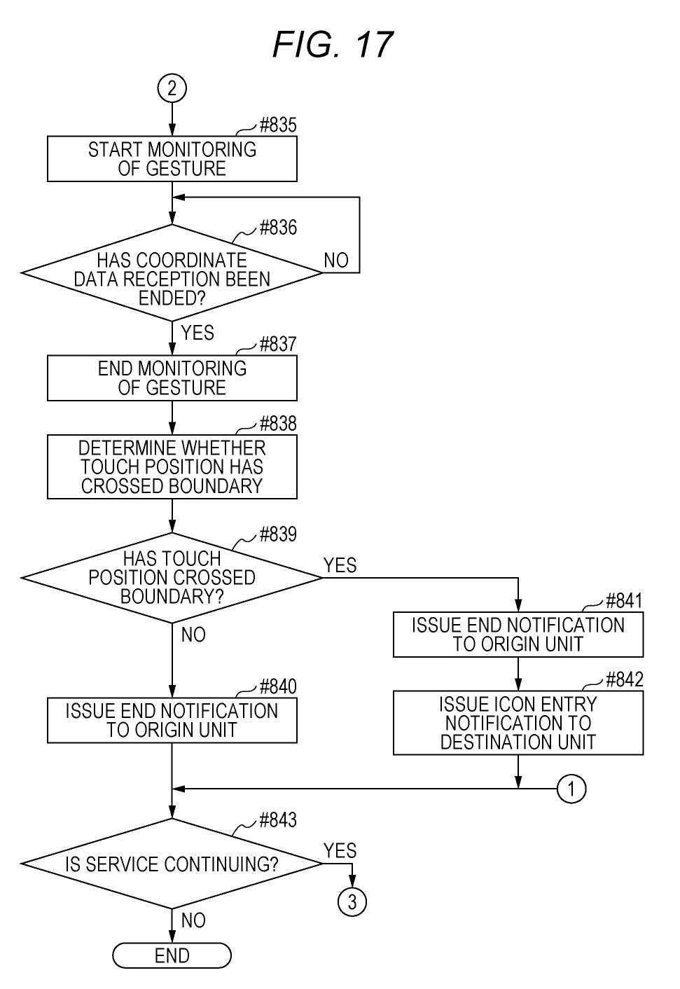

FIG. 15 is a flowchart for explaining an example flow in the overall process to be performed by the MFP unit 2 or the server unit 3. FIGS. 16 and 17 are flowcharts for explaining an example flow in the overall process to be performed by the panel controller 5.

Referring now to the flowcharts, the flow in the overall process to be performed by the MFP unit 2, the server unit 3, and the panel controller 5 is described.

The MFP unit 2 performs the process through the procedures shown in FIG. 15, according to the client program 20P. The server unit 3 performs the process through the procedures shown in FIG. 15, according to the client program 30P. That is, the flow in the overall process to be performed by the MFP unit 2 and the flow in the overall process to be performed by the server unit 3 are basically the same.

The panel controller 5 performs the process through the procedures shown in FIGS. 16 and 17, according to the relay program 50P.

After activation of the operating system, the MFP unit 2 transmits the image data 6A2 and the area data 6A4 of each of the icons constituting a predetermined MFP screen 7A to the panel controller 5 (#801 in FIG. 15). To cause the touch panel display 4 to display this MFP screen 7A as the current MFP screen, the MFP unit 2 further generates the screen data 6A3 of this MFP screen 7A, and transmits the screen data 6A3 to the panel controller 5 (#802). The process in step #802 may be performed at a predetermined frame rate in parallel with the process in step #804, the process in step #809, the process in step #811, or the process in steps #813 and #814. Likewise, the process in step #807 described later may be performed at a predetermined frame rate in parallel with those processes.

After the activation of the operating system, the server unit 3 also transmits the image data 6B2 and the area data 6B4 of each of the icons constituting a predetermined server screen 7B to the panel controller 5 (#801). To cause the touch panel display 4 to display this server screen 7B, the server unit 3 further generates the screen data 6B3 of this server screen 7B, and transmits the screen data 6B3 to the panel controller 5 (#802). The process in step #802 may be performed at a predetermined frame rate in parallel with the processes in step #803 and the subsequent steps.

Upon receipt of coordinate data 6E from the panel controller 5 (Yes in #803), the MFP unit 2 determines the next process (#804). If the next process is determined to be a process of changing the current MFP screen to another MFP screen 7A (Yes in #805), a process of causing the touch panel display 4 to display another MFP screen 7A as the current MFP screen is performed as described above (#801, #802). Otherwise (No in #805), the determined next process is performed in the MFP unit 2 by the operating system or the like as appropriate.

Likewise, upon receipt of the coordinate data 6E from the panel controller 5 (Yes in #803), the server unit 3 determines the next process (#804). If the next process is determined to be a process of changing the current server screen to another server screen 7B (Yes in #805), a process of causing the touch panel display 4 to display another server screen 7B as the current server screen is performed as described above (#801, #802). Otherwise (No in #805), the determined next process is performed in the server unit 3 by the operating system or the like as appropriate.

If the MFP unit 2 receives start notification data 6FA (Yes in #806), the MFP unit 2 generates the screen data 6A3 of the current MFP screen excluding the icon 71 having the identifier indicated by the start notification data 6FA, and transmits the generated screen data 6A3 to the panel controller 5 (#807).

Likewise, if the server unit 3 receives start notification data 6FB (Yes in #806), the server unit 3 generates the screen data 6B3 of the current server screen excluding the icon 73 having the identifier indicated by the start notification data 6FB, and transmits the generated screen data 6B3 to the panel controller 5 (#807).

While the process in step #807 is being performed, the process in step #802 is suspended.

If the MFP unit 2 receives first end notification data 6GA (Yes in #808), the MFP unit 2 updates the screen configuration data 6A1 of the current MFP screen, to move the icon 71 having the identifier indicated by the first end notification data 6GA to the position of the coordinates indicated by the first end notification data 6GA on the current MFP screen (#809). Returning to step #802, the MFP unit 2 then generates the screen data 6A3 of the current MFP screen in accordance with the updated screen configuration data 6A1, and transmits the generated screen data 6A3 to the panel controller 5.

Likewise, if the server unit 3 receives first end notification data 6GB (Yes in #808), the server unit 3 updates the screen configuration data 6B1 of the current server screen, to move the icon 73 having the identifier indicated by the first end notification data 6GB to the position of the coordinates indicated by the first end notification data 6GB on the current server screen (#809). Returning to step #802, the server unit 3 then generates the screen data 6B3 of the current server screen in accordance with the updated screen configuration data 6B1, and transmits the generated screen data 6B3 to the panel controller 5.

If the MFP unit 2 receives second end notification data 6HA (Yes in #810), the MFP unit 2 determines the next process to be a process of transmitting the file corresponding to the icon 71 having the identifier indicated by the second end notification data 6HA to the server unit 3 (#811). This file is then transmitted to the server unit 3 by the operating system.

Likewise, if the server unit 3 receives second end notification data 6JB (Yes in #810), the server unit 3 determines the next process to be a process of transmitting the file corresponding to the icon 73 having the identifier indicated by the second end notification data 6JB to the MFP unit 2 (#811). This file is transmitted to the MFP unit 2 by the operating system.

If the MFP unit 2 receives entry notification data 6JA (Yes in #812), the MFP unit 2 saves the file transmitted from the server unit 3 in the storage area corresponding to the current MFP screen (#813), and performs a process for adding the icon corresponding to the file as the icon 71 to the position of the coordinates indicated by the entry notification data 6JA on the current MFP screen (#814). Specifically, the identifier of the icon is issued, the image data 6B2 included in the entry notification data 6JA is associated with the identifier and is stored as the image data 6A2 of the icon, and the position and the identifier of the icon are added to the screen configuration data 6A1.

The MFP unit 2 then returns to step #801, and transmits the image data 6A2 and the area data 6A4 of each of the icons on the current MFP screen to the panel controller 5 (#801). The MFP unit 2 then generates the screen data 6A3 of the current MFP screen in accordance with the updated screen configuration data 6A1, and transmits the screen configuration data 6A1 to the panel controller 5 (#802).

Likewise, if the server unit 3 receives entry notification data 6HB (Yes in #812), the server unit 3 saves the file transmitted from the MFP unit 2 in the storage area corresponding to the current server screen (#813), and performs a process for adding the icon corresponding to the file as the icon 73 to the position of the coordinates indicated by the entry notification data 6HB on the current server screen (#814). Specifically, the identifier of the icon is issued, the image data 6A2 included in the entry notification data 6HB is associated with the identifier and is stored as the image data 6B2 of the icon, and the position and the identifier of the icon are added to the screen configuration data 6B1.

The server unit 3 then returns to step #801, and transmits the image data 6B2 and the area data 6B4 of each of the icons on the current server screen to the panel controller 5 (#801). The server unit 3 then generates the screen data 6B3 of the current server screen in accordance with the updated screen configuration data 6B1, and transmits the screen configuration data 6B1 to the panel controller 5 (#802).

While the service according to the client program 20P is continuing (Yes in #815), the MFP unit 2 performs the above described process as appropriate. Likewise, while the service according to the client program 30P is continuing (Yes in #815), the server unit 3 performs the above described process as appropriate.

Meanwhile, when the panel controller 5 receives the image data 6A2 and the area data 6A4 from the MFP unit 2, and receives the image data 6B2 and the area data 6B4 from the server unit 3 (Yes in #821 in FIG. 16), the panel controller 5 stores these sets of data (#822). Further, upon receipt of the screen data 6A3 from the MFP unit 2 and the screen data 6B3 from the server unit 3 (#823), the panel controller 5 generates screen data 6C3 in accordance with the screen data 6A3 and the screen data 6B3 (#824), converts the screen data 6C3 into a video signal 6C4, and transmits the video signal 6C4 to the display module 4A (#827). As a result, a combined screen 7C is displayed on the display module 4A.

However, if the touch position is being monitored (Yes in #825), the panel controller 5 updates the screen data 6C3 so that the selected icon is superimposed on the combined screen 7C (#826). The panel controller 5 then converts the updated screen data 6C3 into the video signal 6C4, and transmits the video signal 6C4 to the display module 4A (#827).

Note that the panel controller 5 performs the processes in steps #823 through #827 in parallel with the processes in steps #829 and #830, the process in step #832, the processes in steps #834 and #835, or the processes in steps #837 through #842.

Further, when the panel controller 5 starts receiving the coordinate data 6E from the touch panel module 4B (Yes in #828), the panel controller 5 determines whether the user gesture is a drag (#829). If the user gesture is a drag, the panel controller 5 determines the target of the drag (#830).

If the user gesture is not a drag, and the target of the drag is neither an icon 71 nor an icon 73 (No in #831), the panel controller 5 transmits the coordinate data 6E to the MFP unit 2 in a case where the user gesture is performed on the left region 40L, or performs a shift process on the coordinate data 6E and transmits the coordinate data 6E to the server unit 3 in a case where the user gesture is performed on the right region 40R (#832). While the coordinate data 6E is continuously transmitted from the touch panel module 4B (No in #833), the coordinate data 6E is transmitted to the MFP unit 2 or the server unit 3 (#832).

If the user gesture is a drag, and the target of the drag is an icon 71 or an icon 73 (Yes in #831), the panel controller 5 notifies the MFP unit 2 or the server unit 3 of the start of the drag (#834). Specifically, if the target of the drag is an icon 71, the start notification data 6FA is transmitted to the MFP unit 2. If the target of the drag is an icon 73, the start notification data 6FB is transmitted to the server unit 3.

The panel controller 5 further starts monitoring the touch position (#835 in FIG. 17). Even during the monitoring, the processes in steps #824 through #827 are performed in parallel, and therefore, the selected icon moves with the touch position on the combined screen 7C.

When the transmission of the coordinate data 6E is stopped (Yes in #836), the panel controller 5 ends the monitoring (#837). The panel controller 5 then determines whether the touch position has crossed the boundary 40C (#838), and sends a notification to the MFP unit 2 or the server unit 3 in accordance with the result of the determination as described below.

If the touch position has not crossed the boundary 40C (No in #839), the panel controller 5 transmits the first end notification data 6GA to the MFP unit 2 in a case where the selected icon is an icon 71, and transmits the first end notification data 6GB to the server unit 3 in a case where the selected icon is an icon 73 (#840).

If the touch position has crossed the boundary 40C (Yes in #839), the panel controller 5 transmits the second end notification data 6HA to the MFP unit 2 in a case where the selected icon is an icon 71, and transmits the second end notification data 6JB to the server unit 3 in a case where the selected icon is an icon 73 (#841). Further, the panel controller 5 transmits the entry notification data 6JA to the MFP unit 2 in a case where the selected icon is an icon 71, and transmits the entry notification data 6HB to the server unit 3 in a case where the selected icon is an icon 73 (#842).

While the service according to the relay program 50P is continuing (Yes in #843), the panel controller 5 performs the above described process as appropriate.

According to the first embodiment, in a case where an MFP screen 7A and a server screen 7B are displayed side by side, an icon can cross the screen boundary more easily than in conventional cases.

In the first embodiment, the MFP unit 2 generates data for displaying an entire MFP screen 7A as the screen data 6A3, and transmits the screen data 6A3 to the panel controller 5. Likewise, the server unit 3 generates data for displaying an entire server screen 7B as the screen data 6B3, and transmits the screen data 6B3 to the panel controller 5. The panel controller 5 then extracts some portions from the MFP screen 7A and the server screen 7B in conformity with the sizes of the left region 40L and the right region 40R, and arranges the extracted portions side by side, to generate a combined screen 7C.

However, the MFP unit 2 may extract a portion of the MFP screen 7A in conformity with the size of the left region 40L, and transmit data for displaying this portion as the screen data 6A3 to the panel controller 5. Likewise, the server unit 3 may extract a portion of the server screen 7B in conformity with the size of the right region 40R, and transmit data for displaying this portion as the screen data 6B3 to the panel controller 5. The panel controller 5 may then generate a combined screen 7C in accordance with the screen data 6A3 and the screen data 6B3. This also applies to the second embodiment described later.

In the first embodiment, after a user ends a drag of a selected icon, or after a user drops a selected icon, the panel controller 5 transmits the image data 6A2 or the image data 6B2 of the selected icon to the copy destination of the file corresponding to the selected icon. However, the image data 6A2 or the image data 6B2 may be transmitted immediately after the selected icon crosses the boundary 40C.

### Second Embodiment

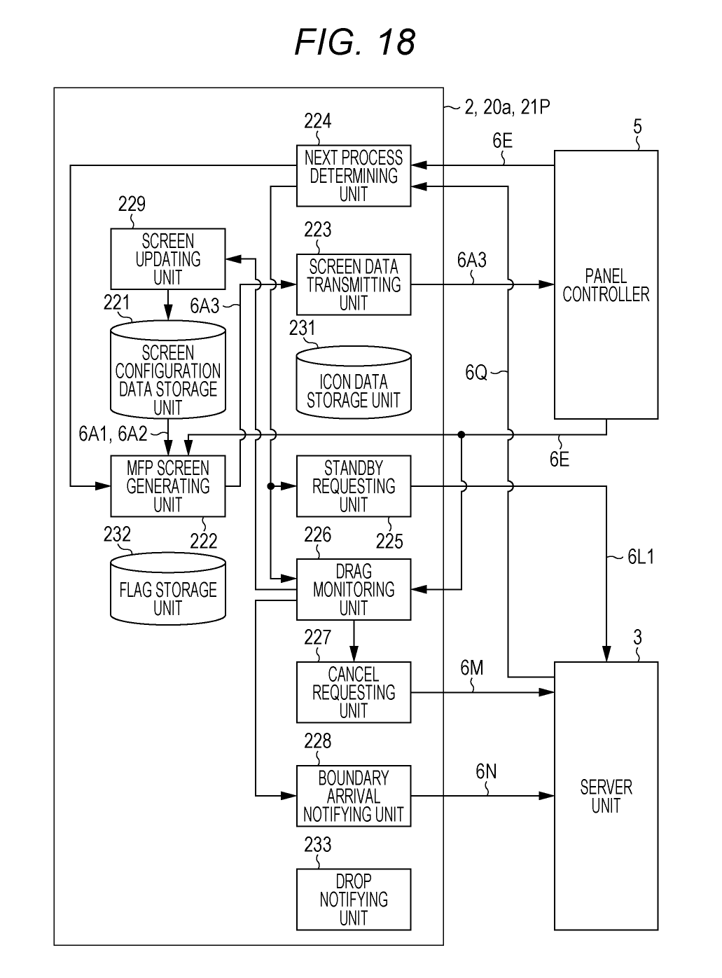

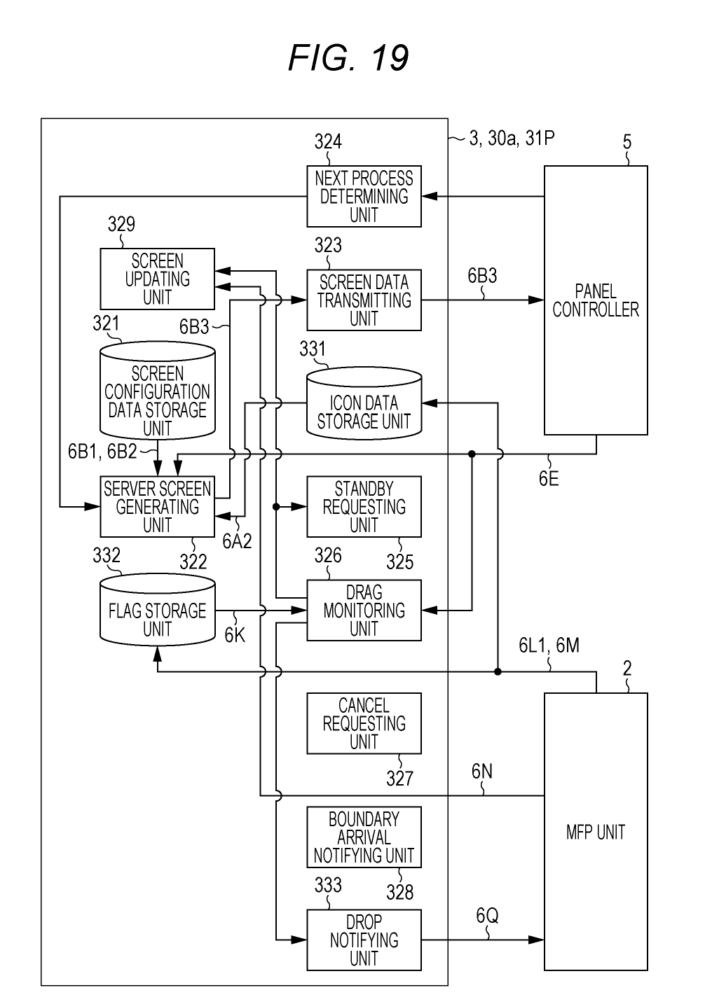

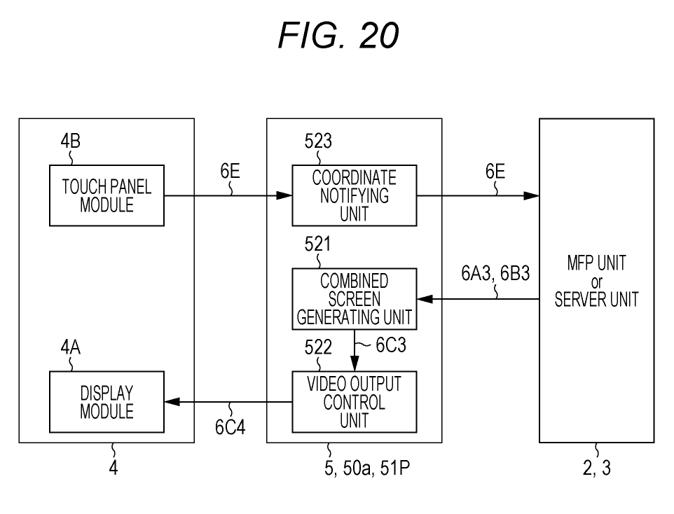

FIG. 18 is a diagram showing an example functional configuration of an MFP unit 2. FIG. 19 is a diagram showing an example functional configuration of a server unit 3. FIG. 20 is a diagram showing an example functional configuration of a panel controller 5.

In the first embodiment, the panel controller 5 performs the process of moving an icon 71 or an icon 73 in accordance with a drag. In a second embodiment, however, the MFP unit 2 and the server unit 3 perform the process. In the description below, the mechanism in which the MFP unit 2 and the server unit 3 perform this process is explained. However, the same aspects as those of the first embodiment are not explained herein.

The configuration of the multi function peripheral 1 is the same as that of the first embodiment, and is as shown in FIG. 1 or 2. The respective hardware configurations of the MFP unit 2, the server unit 3, the touch panel display 4, and the panel controller 5 are also the same as those of the first embodiment, and are as shown in FIGS. 2 through 5.

However, the auxiliary storage device 20d, the auxiliary storage device 30d, and the auxiliary storage device 50d store a client program 21R a client program 31P, and a relay program 51P, respectively, instead of the client program 20P, the client program 30P, and the relay program 50P.

With the client program 21P, a screen configuration data storage unit 221, an MFP screen generating unit 222, a screen data transmitting unit 223, a next process determining unit 224, a standby requesting unit 225, a drag monitoring unit 226, a cancel requesting unit 227, a boundary arrival notifying unit 228, a screen updating unit 229, an icon data storage unit 231, a flag storage unit 232, a drop notifying unit 233, and the like shown in FIG. 18 are formed in the MFP unit 2.

With the client program 31P, a screen configuration data storage unit 321, a server screen generating unit 322, a screen data transmitting unit 323, a next process determining unit 324, a standby requesting unit 325, a drag monitoring unit 326, a cancel requesting unit 327, a boundary arrival notifying unit 328, a screen updating unit 329, an icon data storage unit 331, a flag storage unit 332, a drop notifying unit 333, and the like shown in FIG. 19 are formed in the server unit 3.

With the relay program 51P, a combined screen generating unit 521, a video output control unit 522, a coordinate notifying unit 523, and the like shown in FIG. 20 are formed in the panel controller 5.

[Display of a Combined Screen]

In the MFP unit 2, screen configuration data 6A1 and image data 6A2 are stored beforehand in the screen configuration data storage unit 221, as in the screen configuration data storage unit 201 (see FIG. 6) of the first embodiment.

Like the MFP screen generating unit 202, the MFP screen generating unit 222 generates screen data 6A3.

Like the screen data transmitting unit 203, the screen data transmitting unit 223 transmits the screen data 6A3 generated by the MFP screen generating unit 222 to the panel controller 5.

In the server unit 3, screen configuration data 6B1 and image data 6B2 are stored beforehand in the screen configuration data storage unit 321, as in the screen configuration data storage unit 301 (see FIG. 6).

Like the server screen generating unit 302, the server screen generating unit 322 generates screen data 6B3.

Like the screen data transmitting unit 303, the screen data transmitting unit 323 transmits the screen data 6B3 generated by the server screen generating unit 322 to the panel controller 5.

In the panel controller 5, like the combined screen generating unit 502 (see FIG. 7), the combined screen generating unit 521 generates screen data 6C3 in accordance with the screen data 6A3 and the screen data 6B3.

Like the video output control unit 503, the video output control unit 522 causes the video board 50g to perform a process of converting the screen data 6C3 generated by the combined screen generating unit 521 into a video signal 6C4, and outputting the video signal 6C4 to the display module 4A.

The display module 4A then displays a combined screen 7C in accordance with the video signal 6C4.

[Process for Responding to a Touch]

A standby flag 6K is stored beforehand in the flag storage unit 232. The standby flag 6K is also stored beforehand in the flag storage unit 332. Usage of the standby flag 6K will be described later. The initial value of the standby flag 6K is “0”.

As in the first embodiment, the touch panel module 4B transmits coordinate data 6E to the panel controller 5.

In the panel controller 5, upon receipt of the coordinate data 6E, the coordinate notifying unit 523 transfers the coordinate data 6E to the MFP unit 2, if the coordinates indicated by the coordinate data 6E are coordinates on the left side of the boundary 40C. If the coordinates indicated by the coordinate data 6E are coordinates on the right side of the boundary 40C, the coordinate data 6E is subjected to a shift process, and is then transferred to the server unit 3.

In the MFP unit 2, the next process determining unit 224 determines the user gesture by a known method, in accordance with the coordinate data 6E transmitted from the panel controller 5. The next process determining unit 224 further identifies the object that is the target of the user gesture, in accordance with the screen configuration data 6A1 of the current MFP screen. The next process determining unit 224 then determines the next process, in accordance with the determined user gesture and the identified object.

In the server unit 3, the next process determining unit 324 also determines the next process in accordance with coordinate data 6E transmitted from the panel controller 5, like the next process determining unit 224. In this case, however, the object that is the target of the user gesture is identified in accordance with the screen configuration data 6B1 of the current server screen.

The next process determined by the next process determining unit 224 is then performed in the MFP unit 2. Likewise, the next process determined by the next process determining unit 324 is performed in the server unit 3.

Particularly, in a case where the user gesture is a drag, and the target of the drag is an icon 71, the next process determining unit 224 determines the next process to be a process of moving the icon 71. The process of moving the icon 71, which is the selected icon, is then performed as described below.

The standby requesting unit 225 transmits standby request data 6L1 to the server unit 3, to request the server unit 3 to stand by for movement of the icon 71 from the MFP unit 2 to the server unit 3. The standby request data 6L1 includes the image data 6A2 of the selected icon.

In the server unit 3, when the standby request data 6L1 is transmitted from the MFP unit 2, the standby flag 6K stored in the flag storage unit 332 is updated to “1”. As a result, a standby mode is set to “ON”. The “standby mode” is the mode for standing by for reception of the selected icon.

The icon data storage unit 331 further stores the image data 6A2 included in the standby request data 6L1.

Every time coordinate data 6E is transmitted from the panel controller 5, the MFP screen generating unit 222 regenerates the screen data 6A3 of the current MFP screen, with the selected icon being placed not at the position indicated by the screen configuration data 6A1 of the current MFP screen but at the position indicated by the coordinate data 6E.

The screen data transmitting unit 223 then transmits the screen data 6A3 to the panel controller 5.

In the panel controller 5, the combined screen generating unit 521 then generates the screen data 6C3 of a combined screen 7C in accordance with the screen data 6A3 received from the MFP unit 2 and the screen data 6B3 received from the server unit 3. The video output control unit 522 causes the video board 50g to perform a process of converting the screen data 6C3 into a video signal 6C4 and outputting the video signal 6C4 to the display module 4A. As a result, the state of the selected icon moving with the touch position on the current MFP screen is reproduced.

In the MFP unit 2, the drag monitoring unit 226 monitors the touch position by monitoring the coordinates indicated by the coordinate data 6E sequentially transmitted from the panel controller 5. In other words, the drag monitoring unit 226 monitors the drag.

When the user removes the finger from the current MFP screen without crossing the boundary 40C, the touch position does not reach the right side of the left region 40L, and the transmission of the coordinate data 6E is stopped. The cancel requesting unit 227 and the screen updating unit 229 then perform the process described below.

The cancel requesting unit 227 transmits cancel request data 6M to the server unit 3. In the server unit 3, when the cancel request data 6M is received, the standby flag 6K is updated to “0”. As a result, the standby mode is set to “OFF”. Further, the image data 6A2 is deleted from the icon data storage unit 331.

The screen updating unit 229 updates the screen configuration data 6A1 of the current MFP screen stored in the screen configuration data storage unit 221 so that the selected icon is placed at the position of the coordinates indicated by the latest coordinate data 6E, or the position at which the finger was removed from the screen. After that, the MFP screen generating unit 222 regenerates the screen data 6A3 of the current MFP screen in accordance with the updated screen configuration data 6A1, and the screen data transmitting unit 223 transmits the screen data 6A3 to the panel controller 5.

In a case where the touch position has crossed the boundary 40C, on the other hand, the transmission of the coordinate data 6E is stopped after the touch position has reached the right side of the left region 40L.

The boundary arrival notifying unit 228 then transmits boundary arrival notification data 6N to the server unit 3.

The MFP screen generating unit 222 further regenerates the screen data 6A3 of the current MFP screen, with the selected icon being temporarily excluded from the current MFP screen. The screen data transmitting unit 223 transmits the screen data 6A3 to the panel controller 5.

In a case where the standby flag 6K is “1” in the server unit 3, when the boundary arrival notification data 6N is transmitted from the MFP unit 2, a process for placing the selected icon on the current server screen is performed as described below.

The drag monitoring unit 326 monitors the touch position by monitoring the coordinates indicated by the coordinate data 6E sequentially transmitted from the panel controller 5. In other words, the drag monitoring unit 326 monitors the drag.

Every time the coordinate data 6E is transmitted from the panel controller 5, the server screen generating unit 322 regenerates the screen data 6B3 of the current server screen, with the selected icon being placed at the position of the coordinates indicated by the coordinate data 6E. The screen data transmitting unit 323 then transmits the screen data 6B3 to the panel controller 5.

In the panel controller 5, the combined screen generating unit 521 then generates the screen data 6C3 of a combined screen 7C in accordance with the screen data 6A3 received from the MFP unit 2 and the screen data 6B3 received from the server unit 3. The video output control unit 522 causes the video board 50g to perform a process of converting the screen data 6C3 into a video signal 6C4 and outputting the video signal 6C4 to the display module 4A. As a result, the state of the selected icon moving with the touch position on the current server screen is reproduced.

When the user removes the finger from the current server screen, the transmission of the coordinate data 6E is stopped. The drag monitoring unit 326 then determines that the drag of the selected icon has been completed. That is, the drag monitoring unit 326 determines that the selected icon has been dropped at the touch position.

The drop notifying unit 333 then transmits drop notification data 6Q to the MFP unit 2.

In the MFP unit 2, when the drop notification data 6Q is transmitted from the server unit 3, the next process determining unit 224 determines the next process to be a process of copying the file corresponding to the selected icon from the MFP unit 2 into the server unit 3. The file is then transmitted to the server unit 3 by the operating system of the MFP unit 2.

The operating system of the server unit 3 saves the file in the storage area corresponding to the current server screen.

The screen updating unit 329 then performs a process for newly adding the icon corresponding to the file as an icon 73 to the current server screen. Specifically, the identifier of the icon is issued, and the coordinates of the four vertexes of the smallest rectangle that can surround the icon are added to the screen configuration data 6B1 of the current server screen so that the icon is placed at the position of the coordinates indicated by the latest coordinate data 6E, or at the position at which the selected icon has been dropped. Further, the image data 6A2 stored in the icon data storage unit 331 is associated with the issued identifier and is stored as the image data 6B2 of the icon into the screen configuration data storage unit 321. The image data 6A2 stored in the icon data storage unit 331 is then deleted.

Further, in the MFP unit 2, the MFP screen generating unit 222 regenerates the screen data 6A3 of the current MFP screen, with the selected icon being again placed on the current MFP screen. The screen data transmitting unit 223 transmits the screen data 6A3 to the panel controller 5.

Thus, as in the first embodiment, the file corresponding to the selected icon is copied from the MFP unit 2 into the server unit 3, and the icon 73 of the file is also displayed on the current server screen as shown in FIG. 14.

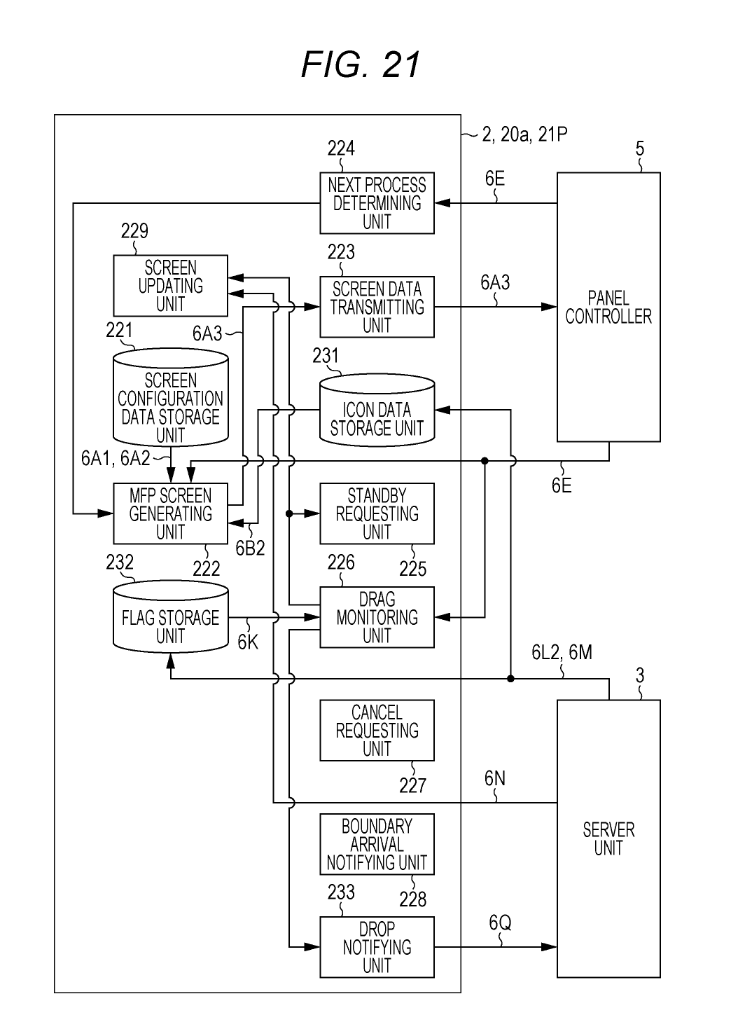

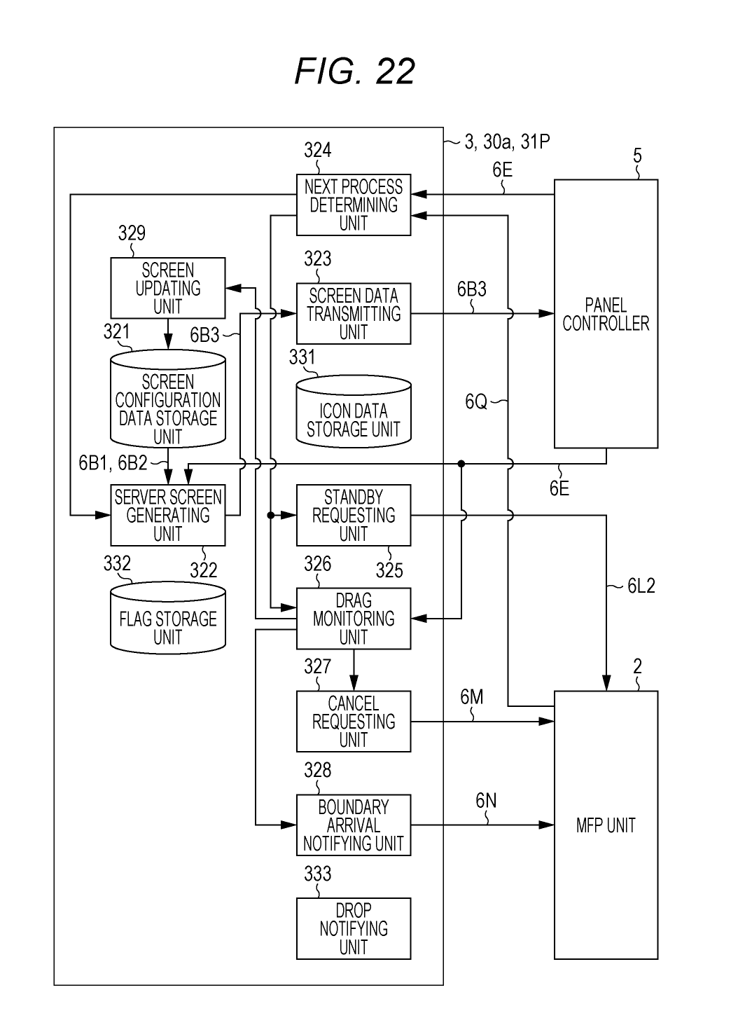

FIG. 21 is a diagram showing an example functional configuration of the MFP unit 2. FIG. 22 is a diagram showing an example functional configuration of the server unit 3.

FIGS. 18 and 19 show the flow of data and the like in a case where the selected icon is an icon 71 and moves from the current MFP screen to the current server screen. In a case where the selected icon is an icon 73 and moves from the current server screen to the current MFP screen, on the other hand, the MFP screen generating unit 222 or the drop notifying unit 233 of the MFP unit 2 performs the same process as the server screen generating unit 322 or the drop notifying unit 333 of the server unit 3, and the server screen generating unit 322 or the drop notifying unit 333 performs the same process as the MFP screen generating unit 222 or the drop notifying unit 233. The flow of data and the like in this case is as shown in FIG. 21 and FIG. 22.

However, instead of the standby request data 6L1, standby request data 6L2 is exchanged. The standby request data 6L2 includes the image data 6B2 of the selected icon. The image data 6B2 is then stored into the icon data storage unit 231, and is used when the selected icon is moved to the current MFP screen.

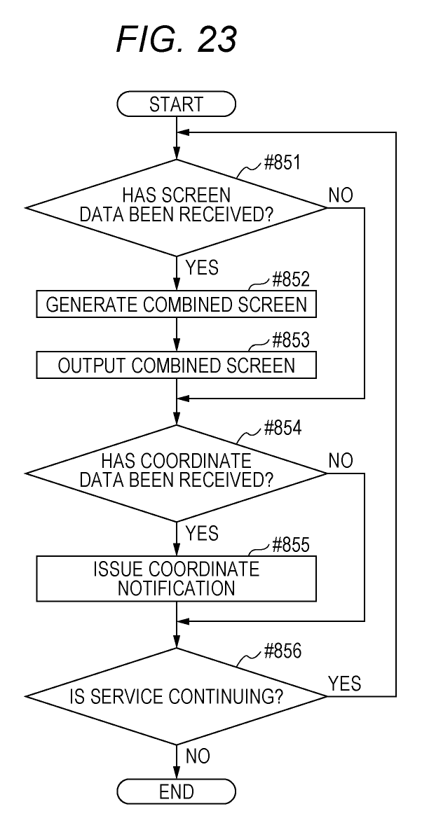

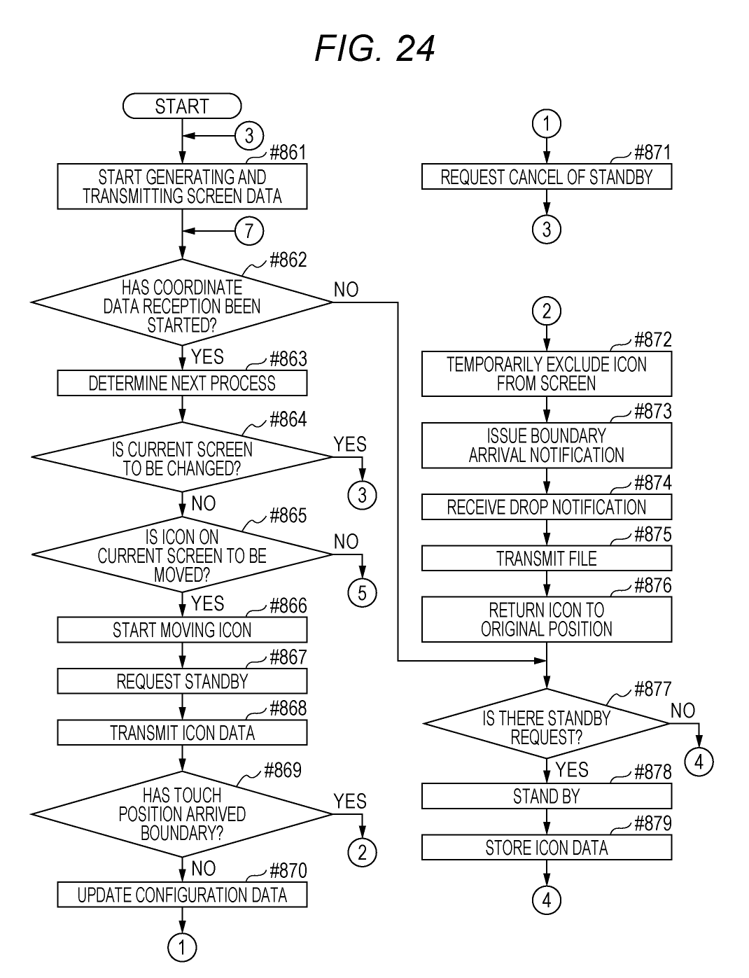

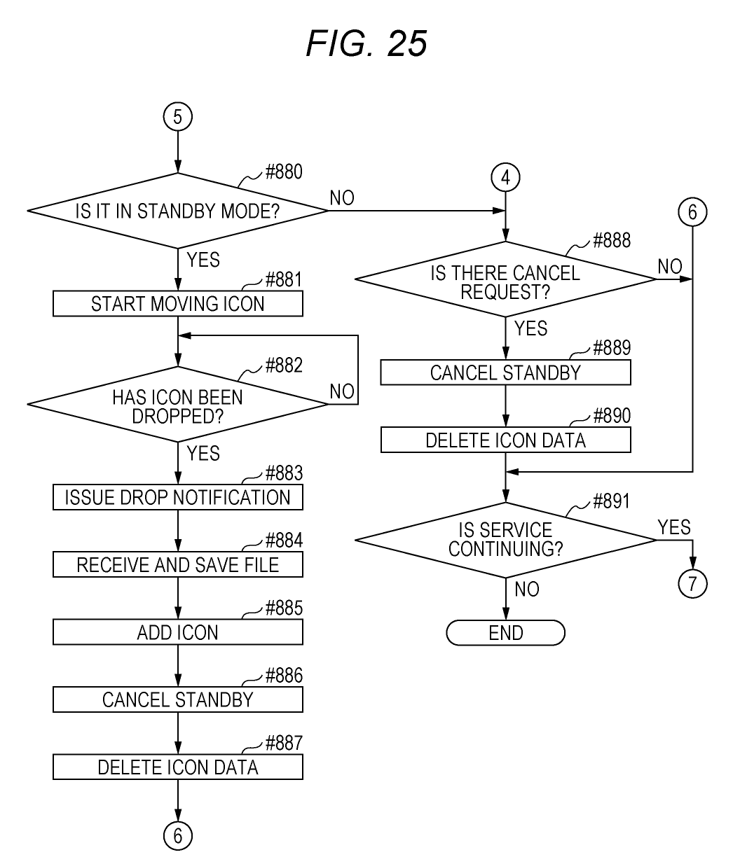

FIG. 23 is a flowchart for explaining an example flow in the overall process to be performed by the panel controller 5. FIGS. 24 and 25 are flowcharts for explaining an example flow in the overall process to be performed by the MFP unit 2 or the server unit 3.

Referring now to the flowcharts, the flow in the overall process to be performed by the MFP unit 2, the server unit 3, and the panel controller 5 is described.

The panel controller 5 performs the process through the procedures shown in FIG. 23, according to the relay program 51P.

Upon receipt of screen data 6A3 from the MFP unit 2 and screen data 6B3 from the server unit 3 (Yes in #851), the panel controller 5 generates screen data 6C3 in accordance with the screen data 6A3 and the screen data 6B3 (#852), converts the screen data 6C3 into a video signal 6C4, and transmits the video signal 6C4 to the display module 4A (#853). As a result, a combined screen 7C is displayed on the display module 4A.

Further, upon receipt of coordinate data 6E from the touch panel module 4B (Yes in #854), the panel controller 5 transmits the coordinate data 6E to the MFP unit 2 in a case where the coordinate data 6E indicates coordinates in the left region 40L, but performs a shift process on the coordinate data 6E and then transmits the resultant coordinate data 6E to the server unit 3 in a case where the coordinate data 6E indicates coordinates in the right region 40R (#855).

While the service according to the relay program 51P is continuing (Yes in #856), the panel controller 5 performs the above described process as appropriate.

The MFP unit 2 performs the process through the procedures shown in FIGS. 24 and 25, according to the client program 21P.

After activation of the operating system, the MFP unit 2 starts generating the screen data 6A3 of a predetermined MFP screen 7A at a predetermined frame rate and transmitting the screen data 6A3 to the panel controller 5, to cause the touch panel display 4 to display this MFP screen 7A as the current MFP screen (#861 in FIG. 24).

When reception of the coordinate data 6E from the panel controller 5 is started (Yes in #862), the MFP unit 2 determines the next process (#863).

If the next process is a process of changing the current MFP screen (Yes in #864), the MFP unit 2 returns to step #861, to start generating the screen data 6A3 of a new current MFP screen and transmitting the screen data 6A3 to the panel controller 5.

If the next process is a process of moving an icon 71 on the current MFP screen (Yes in #865), the MFP unit 2 moves the icon 71 with the touch position on the MFP screen (#866), and transmits standby request data 6L1 to the server unit 3 (#867, #868). Note that the standby request data 6L1 includes the image data 6A2 of the icon 71.

If the icon 71 is dropped without the touch position reaching the boundary 40C (No in #869), the MFP unit 2 updates the screen configuration data 6A1 of the current MFP screen so that the icon 71 is placed at the position of the drop (#870), and transmits cancel request data 6M to the server unit 3 (#871).

If the touch position reaches the boundary 40C before the icon 71 is dropped (Yes in #869), the MFP unit 2 generates screen data 6A3 by temporarily excluding the icon 71 from the current MFP screen, and starts transmitting the generated screen data 6A3 to the panel controller 5 (#872). The MFP unit 2 further transmits boundary arrival notification data 6N to the server unit 3 (#873).

Upon receipt of drop notification data 6Q from the server unit 3 (#874), the MFP unit 2 transmits the file corresponding to the icon 71 to the server unit 3 (#875), and returns the icon 71 to the pre-movement position (#876).

Further, if the MFP unit 2 receives standby request data 6L2 from the server unit 3 (Yes in #877), the MFP unit 2 updates the standby flag 6K to “1” (#878), and temporarily stores the image data 6B2 included in the standby request data 6L2 (#879).

Further, if reception of the coordinate data 6E is started when the standby flag 6K is “1” (Yes in #861, No in #864, No in #865, Yes in #880 in FIG. 25), the MFP unit 2 adjusts the icon 73 (the selected icon) being dragged on the current server screen to the touch position on the MFP screen (#881). Drawing of the selected icon can be performed in accordance with the temporarily stored image data 6B2.

When the transmission of the coordinate data 6E is stopped, or when the selected icon is dropped (Yes in #882), the MFP unit 2 transmits drop notification data 6Q to the server unit 3 (#883). After that, the MFP unit 2 receives the file corresponding to the selected icon from the server unit 3, and saves the file in the storage area corresponding to the current MFP screen (#884). The MFP unit 2 also performs a process for adding, to the current MFP screen, the selected icon as the icon corresponding to the file (#885). Further, the MFP unit 2 updates the standby flag 6K to “0” (#886), and deletes the image data 6B2 of the selected icon (#887).

Upon receipt of cancel request data 6M from the server unit 3 (Yes in #888), the MFP unit 2 also updates the standby flag 6K to “0” (#889), and deletes the image data 6B2 of the selected icon (#890).

While the service according to the client program 21P is continuing (Yes in #891), the MFP unit 2 performs the above described process as appropriate.

The server unit 3 performs the process through the procedures shown in FIGS. 24 and 25, according to the client program 31P. That is, the flow in the overall process to be performed by the server unit 3 is basically the same as the flow in the overall process to be performed by the MFP unit 2.

According to the second embodiment, in a case where an MFP screen 7A and a server screen 7B are displayed side by side, an icon can cross the screen boundary more easily than in conventional cases.

### MODIFICATIONS

### (1) First Modification

In the first embodiment and the second embodiment, the panel controller 5 generates the data of a combined screen 7C, or the screen data 6C3. However, the MFP unit 2 or the server unit 3 may generate the screen data 6C3.

For example, functions equivalent to the icon data storage unit 501 and the combined screen generating unit 502 are provided in both the MFP unit 2 and the server unit 3. Alternatively, functions equivalent to the combined screen generating unit 521 and the video output control unit 522 are provided in both the MFP unit 2 and the server unit 3.

In a case where the MFP unit 2 generates the screen data 6C3, the server unit 3 transmits screen data 6B3 that is the data of the entire current server screen or the data of a portion in conformity with the size of the right region 40R.

The MFP unit 2 then generates screen data 6C3 by combining a portion of the current MFP screen and a portion of the current server screen, and transmits the screen data 6C3 to the panel controller 5.

In a case where the server unit 3 generates the screen data 6C3, on the other hand, the MFP unit 2 transmits screen data 6A3 that is the data of the entire current MFP screen or the data of a portion in conformity with the size of the left region 40L.

The server unit 3 then generates screen data 6C3 by combining a portion of the current MFP screen and a portion of the current server screen, and transmits the screen data 6C3 to the panel controller 5.

In a case where the selected icon is dragged, the MFP unit 2 may generate the screen data 6C3 if the touch position is in the right region 40R, and the server unit 3 may generate the screen data 6C3 if the touch position is in the left region 40L. For example, in a case where the selected icon is on an MFP screen 7A, the MFP unit 2 generates the screen data 6C3 after the drag of the selected icon is started until the selected icon crosses the boundary 40C. After the selected icon crosses the boundary 40C, the server unit 3 generates the screen data 6C3 until the selected icon is dropped. In other words, the unit that performs the drawing of a combined screen 7C is switched between the MFP unit 2 and the server unit 3, depending on the touch position.

Further, a VRAM and a video board may be provided in both the MFP unit 2 and the server unit 3, and a function equivalent to the video output control unit 503 or 523 may be provided in both the MFP unit 2 and the server unit 3. The MFP unit 2 or the server unit 3 may then convert the screen data 6C3 into a video signal 6C4, and transmit the video signal 6C4 to the display module 4A, without the video signal 6C4 passing through the panel controller 5.

### (2) Second Modification

In the first embodiment, the second embodiment, and the first modification, the panel controller 5 allocates coordinate data 6E to the MFP unit 2 or the server unit 3. However, coordinate data 6E may be transmitted to both the MFP unit 2 and the server unit 3.

If the coordinates indicated by the coordinate data 6E are those in the left region 40L, the MFP unit 2 performs a process as described above in accordance with the coordinates. If the coordinates indicated by the coordinate data 6E are those in the right region 40R, the server unit 3 performs a shift process on the coordinate data 6E, and performs a process as described above in accordance with the coordinates indicated in the coordinate data 6E subjected to the shift process.

### (3) Third Modification

In the first embodiment, the second embodiment, the first modification, and the second modification, in a case where the selected icon is dragged and dropped from the current MFP screen onto the current server screen, the file corresponding to the selected icon is copied from the MFP unit 2 into the server unit 3. However, the file corresponding to the selected icon may be moved from the MFP unit 2 to the server unit 3. In other words, the file may be deleted from the MFP unit 2.

### (4) Other Modifications

In a case where the selected icon is not an icon of a file but an icon of a folder, the MFP unit 2 or the server unit 3 transmits the folder to the other.

If transfer of the object corresponding to the selected icon is disabled, the MFP unit 2 or the server unit 3 may be prohibited from moving the selected icon from one screen to the other.

In a case where the direction in which the selected icon is dragged is not toward the boundary 40C, the unit (apparatus) having the screen on which the selected icons is located should perform a process of moving the selected icon in a conventional manner, the unit being the MFP unit 2 or the server unit 3. Further, in this case, it is not necessary to perform a preparation process (such as transmission of image data 6A2 or 6B2, and area data 6A4 or 6B4) for the selected icon to move beyond the boundary 40C.

During a drag, processes such as data exchange, data conversion, and an image drawing operation are performed after the touched position is detected by the touch panel module 4B until the selected icon is moved to and displayed at the position. These processes take time. That is, a time lag is caused.

Therefore, the MFP unit 2 or the server unit 3 may predict the time at which the touch position reaches the boundary 40C, from the touch position, the dragging speed, and the time lag. The MFP unit 2 or the server unit 3 may then transmit the image data 6A2 or 6B2 and the area data 6A4 or 6B4 of the selected icon a predetermined time (such as one second) before the predicted time. Also, boundary arrival notification data 6N may be transmitted at that time.

Further, it is possible to make appropriate modifications, within the scope of the present invention, to the configurations of the entire multi function peripheral 1, the entire MFP unit 2, and the entire server unit 3, the configurations of the respective components of the multi function peripheral 1, the MFP unit 2, and the server unit 3, the details of the processes, the sequence of the processes, the data structures, the screen configurations, and the like.

Although embodiments of the present invention have been described and illustrated in detail, the disclosed embodiments are made for purposes of illustration and example only and not limitation. The scope of the present invention should be interpreted by terms of the appended claims.

What is claimed is:

1. A multi function peripheral that includes a first system, a second system, and a display, the multi function peripheral comprising
a display controller that causes the display to display a first screen of the first system and a second screen of the second system side by side, wherein
the first system includes a supplier that supplies image data of an icon placed on the first screen to the second system or the display controller, and
when an operation to move the icon from the first screen to the second screen is performed, the display controller causes the display to display the icon moving from the first screen to the second screen in accordance with the operation.

2. The multi function peripheral according to claim 1, wherein
the operation is an operation to drag the icon, and
the supplier supplies the image data when the icon starts being dragged.

3. The multi function peripheral according to claim 1, wherein
the operation is an operation to drag the icon in a direction from the first screen toward the second screen, and
the supplier supplies the image data, when the operation is performed and the icon belongs to a file or a folder that can be exchanged between the first system and the second system.

4. The multi function peripheral according to claim 2, wherein
the first system includes a transmitter that transmits a file or a folder corresponding to the icon to the second system, when the icon is dropped onto the second screen, and
the second system includes a positioner that associates the icon with the file or the folder transmitted from the first system and places the file or the folder on the second screen, when the icon is dropped onto the second screen.

5. The multi function peripheral according to claim 1, further comprising:
a first apparatus; a second apparatus; and a controller that is connectable to the first apparatus and the second apparatus and is capable of outputting a video signal to the display, wherein
the first system is included in the first apparatus,
the second system is included in the second apparatus, and
the display controller is included in the controller.

6. The multi function peripheral according to claim 1, further comprising:
a first apparatus; and a second apparatus, wherein
the first system is included in the first apparatus,
the second system is included in the second apparatus, and
the display controller is controlled by one of the first apparatus and the second apparatus.

7. The multi function peripheral according to claim 2, further comprising:
a first apparatus; and a second apparatus, wherein
the first system is included in the first apparatus,
the second system is included in the second apparatus,
the display controller is included as a first display controller and a second display controller in the first apparatus and the second apparatus, respectively,
when the icon is dragged on the first screen, the first display controller causes the display to display the first screen and the second screen, and
when the icon is dragged on the second screen, the second display controller causes the display to display the first screen and the second screen.

8. A display sharing method for sharing a display between a first system and a second system, the display sharing method comprising:
causing the display to display a first screen of the first system and a second screen of the second system side by side, a display controller causing the display to display the first screen and the second screen;
supplying image data of an icon placed on the first screen to the second system and the display controller, the first system supplying the image data; and
when an operation to move the icon from the first screen to the second screen is performed, causing the display to display the icon moving from the first screen to the second screen in accordance with the operation, the display controller causing the display to display the icon.

9. A non-transitory recording medium storing a computer readable program to be used in a computer to cause a first system and a second system to share a display,
the computer readable program causing the computer to perform:
causing the display to display a first screen of the first system and a second screen of the second system side by side;
receiving image data of an icon placed on the first screen from the first system; and
when an operation to move the icon from the first screen to the second screen is performed, causing the display to display the icon moving from the first screen to the second screen in accordance with the operation.

10. A non-transitory recording medium storing a computer readable program to be used in a computer that shares a display with another computer,
the computer readable program causing the computer to perform:
causing the display to display a first screen of the computer and a second screen of the another computer side by side;
transmitting image data of an icon placed on the first screen to the another computer; and
when an operation to move the icon from the first screen to the second screen is performed, causing the display to display the icon moving from the first screen to the second screen in accordance with the operation.
